(19) United States
(12) Patent Application Publication
(10) Pub. No.: US 2013/0185806 A1
(43) Pub. Date: Jul. 18, 2013

(54) PERSONAL-INFORMATION TRANSMISSION/RECEPTION SYSTEM, PERSONAL-INFORMATION TRANSMISSION/RECEPTION METHOD, PERSONAL-INFORMATION PROVISION APPARATUS, PREFERENCE MANAGEMENT APPARATUS AND COMPUTER PROGRAM

(71) Applicant: Makoto Hatakeyama, Tokyo (JP)

(72) Inventor: Makoto Hatakeyama, Tokyo (JP)

(73) Assignee: NEC CORPORATION, Tokyo (JP)

(21) Appl. No.: 13/876,130

(22) PCT Filed: Sep. 26, 2011
(86) PCT No.: PCT/JP2011/072695

§ 371 Date: Mar. 26, 2013

(30) Foreign Application Priority Data
Oct. 5, 2010 (JP) 2010-225741

(51) Int. Cl. G06F 21/62

(52) U.S. Cl. CPC G06F 21/62
USPC 726/27

(57) ABSTRACT

Disclosed is a personal-information (PI) transmission/reception system and the like which makes it possible to, even when the number of apparatuses possessing PI has increased, reduce a burden of a user who sets preferences (PRFs) with respect to disclosures of the PI on the individual apparatuses.

In the PI transmission/reception system, a PI acquisition apparatus transmits PI to a PI provision apparatus. The PI provision apparatus requests a PRF with respect to disclosures of the PI to a preference management apparatus (PMA). The PMA presents a confirmation PRF which the PMA has generated based on a PRF having been requested and past PRFs having been stored in advance in a PRF storage unit. A user terminal confirms the presented PRF, and transmits a PRF resulting from the confirmation to the PI provision apparatus. When having determined, based on the received PRF, that it is possible to disclose the PI to the PI acquisition apparatus, the PI provision apparatus transmits the PI to the PI acquisition apparatus.

### TECHNICAL FIELD

The present invention relates to a technical field in which personal information is transmitted and received via communication networks. In particular, the present invention relates to a technical field in which, based on a user preference with respect to disclosures of personal information, the personal information is transmitted and received among a plurality of apparatuses via communication networks.

### BACKGROUND ART

There are well-known personal-information transmission/reception systems, in which, based on a user preference with respect to disclosures of personal information, the personal information is transmitted and received among a plurality of apparatuses via communication networks (hereinafter, abbreviated as just “networks”). Here, the user preference with respect to transmission/reception of personal information is information (data) representing conditions with respect to provision of personal information from an apparatus possessing the personal information to a different apparatus, permission or non-permission of the provision thereof, and the like. In general, the user preference is information which is prescribed by a user who can be identified by the user preference. Hereinafter, in this patent application, a user preference with respect to disclosures of personal information will be sometimes referred to as just a “preference”.

For example, the preference includes information in which a usage purpose and a disclosure scope are prescribed for each kind of personal information. Further, in some cases, a preference is generated by a user who is the subject of personal information, and, in other cases, a preference is generated by a provider who provides a service by using personal information. A preference generated by a person other than a user becomes valid when the preference has been approved by the user.

Non-patent literature (NPL) 1 discloses an example of such a personal-information transmission/reception system. FIG. 33 is a block diagram of a personal-information transmission/reception system disclosed in NPL 1 as a related art. As shown in FIG. 33, the personal-information transmission/reception system disclosed in NPL 1 includes a web service provider (hereinafter, referred to as WSP), a web service consumer (hereinafter, referred to as WSC) and a user agent. The WSP possesses personal information of an end user. The WSC provides the end user with a service utilizing the personal information of the end user via the user agent. The user agent is constituted by a general web browser or the like, and has the function of redirecting access destinations. The WSP provides personal information to the WSC only when the provision of the personal information to the WSC has been agreed by the end user.

The personal-information transmission/reception system described in NPL 1 operates as follows. First, the user agent requests a service provision by accessing the WSC, (step Z1). Next, the WSC transmits a message for requesting personal information to the WSP (step Z2). The WSP, which has received the request message, determines whether or not a permission confirmation (permission confirmation processing) by the end user with respect to the provision of the personal information to the WSC has been completed. If the permission confirmation by the end user is not yet completed, the WSP transmits a message, in which the necessity of a permission confirmation by the end user is stated, to the WSC (step Z3). This message is a response message to the WSC with respect to the request message in step Z2. This response message includes a message indicating that a permission confirmation by the end user is necessary, and a permission-confirmation uniform resource locator (URL) of the WSP.

When having received the response message, the WSC redirects the user agent so as to cause the user agent to access the permission-confirmation URL of the WSP included in the response message (step Z4). When having received an access from the user agent to the permission-confirmation URL through this redirection, the WSP confirms with the user agent whether or not it is permitted to provide the personal information to the WSC (step Z5). Subsequently, the WSP redirects the user agent to the WSC (step Z6). When having been accessed by the user agent again, the WSC transmits a message for requesting personal information to the WSP again (step Z7). At this time, when, in step Z5 described above, having already acquired information which permits the provision of the personal information to the WSC, the WSP provides the WSC with a message including the personal information (step Z8). The WSC, which has acquired the personal information, provides the user agent with a service based on the acquired personal information (step Z9).

As described above, in the personal-information transmission/reception system described in NPL 1, the WSP possessing personal information performs direct communication with the user agent, and thereby, acquires a preference with respect to the disclosure of the personal information, and provides the WSC with the personal information.

Patent literature (PTL) 1 discloses another personal-information transmission/reception system. FIG. 34 is a block diagram of a personal-information transmission/reception system disclosed in PTL 1 as another related art. As shown in FIG. 34, this personal-information transmission/reception system disclosed in PTL 1 is configured such that a Web server and a customer terminal is connected to each other via a network.

This personal-information transmission/reception system disclosed in PTL 1 operates as follows. First, the Web server transmits a temporary ID (ID: identifier or identification information) to the customer terminal, the temporary ID having been issued to a customer of the customer terminal. Next, the customer terminal logs in the Web server by using the temporary ID. Next, the Web server presents individual items, which have been determined in advance as a privacy policy, to the customer terminal. Further, in response to operation performed by the end user, the customer terminal transmits information representing the agreement or disagreement with respect to the individual items of the privacy policy to the Web server. When having determined that this temporary ID can be registered, based on the received information, the Web server registers the temporary ID as well as the information representing the agreement or disagreement with respect to the individual items as a profile with respect to the end user, and delivers a real ID to the end user.

As described above, in the personal-information transmission/reception system disclosed in PTL 1, the Web server directly acquires a preference representing the agreement or disagreement with respect to individual items of a privacy policy from the customer terminal, and thereby, realizes a service provision based on the customer's agreement.

That is, in each of the personal-information transmission/reception systems disclosed in NPL 1 and PTL 1, an apparatus possessing personal information performs direct communication with a terminal operated by a user who is a subject of the personal information, and thereby, acquires a preference with respect to disclosures of the personal information.

### CITATION LIST

### Patent Literature

[PTL 1] Japanese Patent Application Unexamined Publication No. 2006-99407

### Non-Patent Literature

[NPL 1] Liberty Alliance Project “Liberty ID-WSF Interaction Service Specification” [online], Jul. 30, 2006, [Jul. 15, 2010, search], Internet, <URL http://www.projectliberty.org/liberty/content/download/3461/23009/file/liberty-id-wsf-int eraction-svc-v2.0-original.pdf>

### SUMMARY OF INVENTION

### Technical Problem

In the personal-information transmission/reception system disclosed in NPL 1 and PTL 1, however, in case that a plurality of apparatuses possesses personal information, a user needs to perform settings or permissions of respective preferences for the personal information possessed by the plurality of apparatuses. For this reason, in each of the personal-information transmission/reception systems described in NPL 1 and PTL 1, there is a problem that a burden of a user who sets preferences increases in proportion to the increase of the number of apparatuses possessing personal information.

Specifically, in each of the personal-information transmission/reception systems described in NPL 1 and PTL 1, for a plurality of apparatuses possessing personal information, the user needs to, for each kind of the personal information, register a determination result regarding permission or non-permission of information disclosure. In order to determine permission or non-permission of disclosures regarding personal information, the user needs to grasp the details of handling of the personal information in each of the apparatuses possessing the personal information. Accordingly, with the increase of the number of apparatuses possessing personal information, an amount of information to be grasped by the user increases, thereby causing the burden of the user in the determination relating to permission or non-permission of the disclosure to increase.

For example, in the personal-information transmission/reception system disclosed in NPL 1, the user needs to determine permission or non-permission of disclosures for each of the WSPs. Accordingly, the increase of the number of the WSPs causes an amount of information related to the WSPs to be grasped by the user to increase, so that the burden of the user increases.

Further, in the personal-information transmission/reception system described in PTL 1, the user also needs to determine agreements with respect to the respective items stated in the privacy policy for each of the Web servers. Accordingly, the burden of the user increases along with the increase of the number of the Web servers.

Moreover, when setting preferences on a plurality of apparatuses possessing personal information, it is a burden for a user to set the preferences such that the preferences are not inconsistent among the apparatuses. This is because, when setting preferences on such a plurality of apparatuses, because of human characteristics, it is difficult for a user to set preferences on the respective apparatuses based on a criterion which is consistent from beginning to end. For this reason, sometimes, a user gives disclosure permission to one of pieces of personal information of the same kind which are independently possessed by different apparatuses. For example, although a user prohibits a provider A from providing address information to a provider B, the user may permit a provider C to provide the address information to the provider B. In this case, with respect to preferences set by the user, there is an inconsistency between a preference for the provider A and a preference for the provider C. Besides, it is difficult for the user to confirm that the user has set such inconsistent preferences.

Thus, when either of the personal-information transmission/reception systems described in NPL 1 and PTL 1 is employed, with the increase of the number of a plurality of apparatuses possessing personal information related to a certain user, the burden of the user who needs to set preferences such that the preferences are not inconsistent among the apparatuses increases.

The present invention has been made in order to solve the aforementioned problem. A main object of the present invention is to provide a personal-information transmission/reception system and the like which makes it possible to, even when the number of apparatuses possessing personal information has increased, reduce a burden of a user who sets preferences with respect to disclosures of the personal information on the individual apparatuses.

### Solution to Problem

As an aspect for solving the above-mentioned object (problem), a personal-information transmission/reception system according to the present invention includes a personal-information acquisition apparatus, a personal-information provision apparatus, a preference management apparatus and a user terminal.

Further, in this personal-information transmission/reception system, the personal-information acquisition apparatus includes:
personal-information request means that transmits a personal information request message, which represents a request for personal information necessary for a service provision to the user terminal, to the personal-information provision apparatus; and
personal-information reception means that receives the personal information from the personal-information provision apparatus.

Further, the personal-information provision apparatus includes:
personal-information storage means that stores the personal information;
personal-information request reception means that receives the personal information request message from the personal-information acquisition apparatus; a preference request means that transmits a preference request message, which represents a request for a preference representing prescription with respect to a disclosure of the personal information, to the preference management apparatus in response to reception of the personal information request message;
preference reception means that receives the preference from the preference management apparatus;
disclosure permission/non-permission determination means that determines whether or not it is possible to disclose the personal information to the personal-information acquisition apparatus, based on the preference received by the preference reception means; and
personal-information transmission means that, if it is determined by the disclosure permission/non-permission determination means that it is possible to disclose the personal information, reads out the personal information from the personal-information storage means, and transmits the read-out personal information to the personal-information acquisition apparatus.

Further, the preference management apparatus includes
preference storage means that stores a preference which has been set in the past by the user terminal;
preference request reception means that receives the preference request message from the personal-information provision apparatus; a confirmation preference generation means that generates a confirmation preference, which is to be presented to the user terminal, based on the past preference stored in the preference storage means as well as the preference request message;
preference confirmation means that presents the confirmation preference to the user terminal, and receives a preference, which is set based on the presented confirmation preference, form the user terminal; and a preference transmission means that transmits the preference received by the preference confirmation means to the personal-information provision apparatus.

Further, the user terminal includes:
preference setting means that sets a preference with respect to a disclosure of the personal information from the personal-information provision apparatus to the personal-information acquisition apparatus, based on the confirmation preference presented by the preference management apparatus, and transmits the preference having been set thereby to the preference management apparatus.

As another aspect for solving the aforementioned object, a personal-information transmission/reception method according to the present invention for use in a personal-information acquisition apparatus, a personal-information provision apparatus, a preference management apparatus and a user terminal.

That is, the personal-information transmission/reception method includes:

transmitting, by the personal-information acquisition apparatus, a personal information request message, which represents a request for personal information necessary for a service provision to the user terminal, to the personal-information provision apparatus;

storing, by the personal-information provision apparatus, the personal information in advance;

receiving, by the personal-information provision apparatus, the personal information request message from the personal-information acquisition apparatus;

transmitting, by the personal-information provision apparatus, a preference request message, which represents a request for a preference representing prescription with respect to a disclosure of the personal information, to the preference management apparatus in response to reception of the personal information request message;

storing, by the preference management apparatus, a preference in advance, which has been set in the past by the user terminal, into a preference storage means;

receiving, by the preference management apparatus, the preference request message from the personal-information provision apparatus;

generating, by the preference management apparatus, a confirmation preference, which is to be presented to the user terminal, based on the past preference stored in the preference storage means as well as the preference request message; presenting, by the preference management apparatus, the confirmation preference to the user terminal; setting, by the user terminal, a preference with respect to a disclosure of the personal information from the personal-information provision apparatus to the personal-information acquisition apparatus, based on the confirmation preference presented from the preference management apparatus;

transmitting, by the user terminal, the set preference to the preference management apparatus; receiving, by the preference management apparatus, the preference having been set thereby from the user terminal;

transmitting, by the preference management apparatus, the received preference to the personal-information provision apparatus; receiving, by the personal-information provision apparatus, the preference from the preference management apparatus; determining, by the personal-information provision apparatus, whether or not it is possible to disclose the personal information to the personal-information acquisition apparatus;

reading out, by the personal-information provision apparatus, the personal information from the personal-information storage means to transmit the read-out personal information to the personal-information acquisition apparatus if it is determined that it is possible to disclose the personal information; and receiving, by the personal-information acquisition apparatus, the personal information from the personal-information provision apparatus.

As a further aspect for solving the aforementioned object, a personal-information provision apparatus according to the present invention includes:

personal-information storage means that stores the personal information; a personal-information request reception means that receives the personal information request message from the personal-information acquisition apparatus;

preference request means that transmits a preference request message, which represents a request for a preference representing prescription with respect to a disclosure of the personal information, to the preference management apparatus in response to reception of the personal information request message;

preference reception means that receives the preference from the preference management apparatus;

disclosure permission/non-permission determination means that determines whether or not it is possible to disclose the personal information to the personal-information acquisition apparatus, based on the preference received by the preference reception means, and

personal-information transmission means that, if it is determined by the disclosure permission/non-permission determination means that it is possible to disclose the personal information, reads out the personal information from the personal-information storage means, and transmits the read-out personal information to the personal-information acquisition apparatus.

As a further aspect for solving the aforementioned object, a preference management apparatus according to the present invention includes:

preference storage means that stores a preference which has been set in the past by the user terminal, and which represents prescription with respect to a disclosure from a personal-information provision apparatus to a personal-information acquisition apparatus;

preference request reception means that receives the preference request message from the personal-information provision apparatus;

confirmation preference generation means that generates a confirmation preference which is to be presented to the user terminal based on the past preference stored in the preference storage means as well as the preference request message;

preference confirmation means that presents the confirmation preference to the user terminal, and receives a preference, which is set based on the presented confirmation preference, form the user terminal; and

preference transmission means that transmits the preference received by the preference confirmation means to the personal-information provision apparatus.

In addition, the aforementioned object can be also achieved by a computer program which causes a computer to realize the function of the personal-information provision apparatus and/or the preference management apparatus which are/is configured in such a way as described above, as well as a computer-readable storage medium storing the computer program.

### Advantageous Effects of Invention

According to the present invention, it is possible to provide a personal-information transmission/reception system and the like which, even when the number of apparatuses possessing personal information has increased, makes it possible to reduce a burden of a user who sets preferences with respect to disclosures of the personal information.

### BRIEF DESCRIPTION OF DRAWINGS

FIG. 1 is block diagram of a personal-information transmission/reception system as a first exemplary embodiment of the present invention.

FIG. 2 is a hardware block diagram of a personal-information provision apparatus in a first exemplary embodiment of the present invention.

FIG. 3 is a hardware block diagram of a personal-information acquisition apparatus in a first exemplary embodiment of the present invention.

FIG. 4 is a hardware block diagram of a preference management apparatus in a first exemplary embodiment of the present invention.

FIG. 5 is a hardware block diagram of a user terminal in a first exemplary embodiment of the present invention.

FIG. 6 is a functional block diagram of a personal-information provision apparatus in a first exemplary embodiment of the present invention.

FIG. 7 is a functional block diagram of a personal-information acquisition apparatus in a first exemplary embodiment of the present invention.

FIG. 8 is a functional block diagram of a preference management apparatus in a first exemplary embodiment of the present invention.

FIG. 9 is a functional block diagram of a user terminal in a first exemplary embodiment of the present invention.

FIG. 10 is a flowchart illustrating an outline of personal information transmission operation of a personal-information transmission/reception system as a first exemplary embodiment of the present invention.

FIG. 11 is a flowchart illustrating preference request processing of a personal-information transmission/reception system as a first exemplary embodiment of the present invention.

FIG. 12 is a flowchart illustrating preference confirmation processing of a personal-information transmission/reception system as a first exemplary embodiment of the present invention.

FIG. 13 is a flowchart illustrating personal information provision processing of a personal-information transmission/reception system as a first exemplary embodiment of the present invention.

FIG. 14 is a block diagram of a personal-information transmission/reception system as a second exemplary embodiment of the present invention.

FIG. 15 is a functional block diagram of a personal-information provision apparatus in a second exemplary embodiment of the present invention.

FIG. 16 is a flowchart illustrating preference request processing in a personal-information transmission/reception system as a second exemplary embodiment of the present invention.

FIG. 17 is a block diagram of a personal-information transmission/reception system as a third exemplary embodiment of the present invention.

FIG. 18 is a functional block diagram of a personal-information provision apparatus in a third exemplary embodiment of the present invention.

FIG. 19 is a flowchart illustrating preference request processing in a personal-information transmission/reception system as a third exemplary embodiment of the present invention.

FIG. 20 is a block diagram of a personal-information transmission/reception system as a fourth exemplary embodiment of the present invention.

FIG. 21 is a functional block diagram of a user terminal in a fourth exemplary embodiment of the present invention.

FIG. 22 is a functional block diagram of a preference management apparatus in the fourth exemplary embodiment of the present invention.

FIG. 23 is a flowchart illustrating preference change processing of a personal-information transmission/reception system as a fourth exemplary embodiment of the present invention.

FIG. 24 is a block diagram of a personal-information transmission/reception system as a fifth exemplary embodiment of the present invention.

FIG. 25 is a functional block diagram of a preference management apparatus in a fifth exemplary embodiment of the present invention.

FIG. 26 is a flowchart illustrating personal information acquisition processing of a personal-information transmission/reception system as a fifth exemplary embodiment of the present invention.

FIG. 27 is a flowchart illustrating preference confirmation processing of a personal-information transmission/reception system as a fifth exemplary embodiment of the present invention.

FIG. 28 is a flowchart illustrating preference confirmation estimation processing of a personal-information transmission/reception system as a fifth exemplary embodiment of the present invention.

FIG. 29 is a block diagram of a mobile-telephone-terminal shopping portal system as a sixth exemplary embodiment of the present invention.

FIG. 30 is a sequence diagram illustrating operation of a mobile-telephone-terminal shopping portal system as a sixth exemplary embodiment of the present invention.

FIG. 31 is a block diagram of an ASP foundation system as a seventh exemplary embodiment of the present invention.

FIG. 32 is a sequence diagram illustrating operation of an ASP foundation system as a seventh exemplary embodiment of the present invention.

FIG. 33 is a block diagram of a personal-information transmission/reception system as a related art.

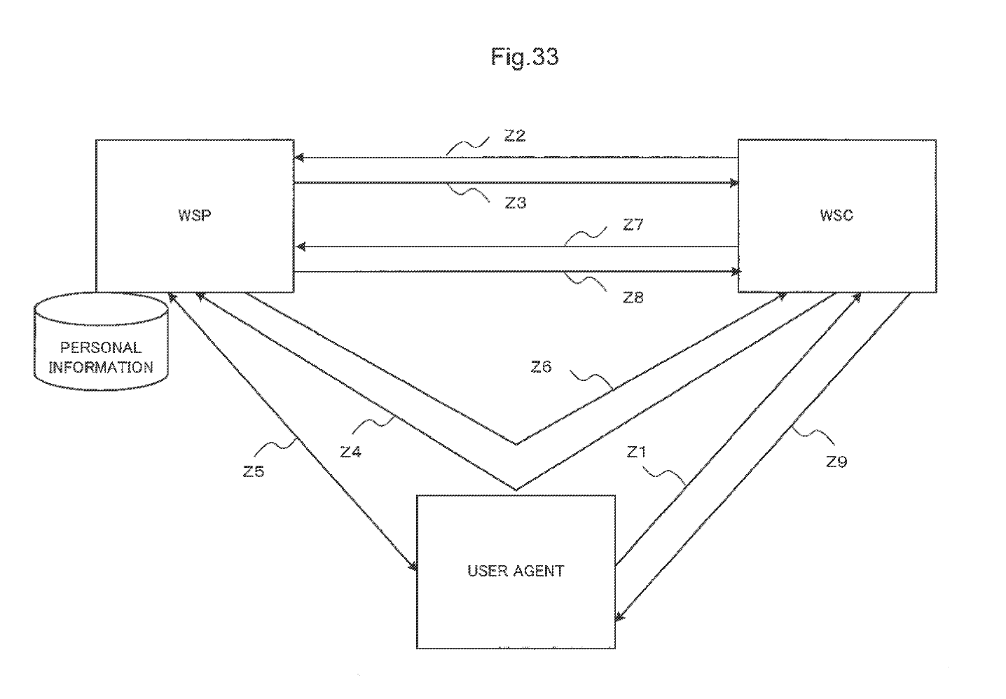

FIG. 34 is a block diagram of a personal-information transmission/reception system as another related art.

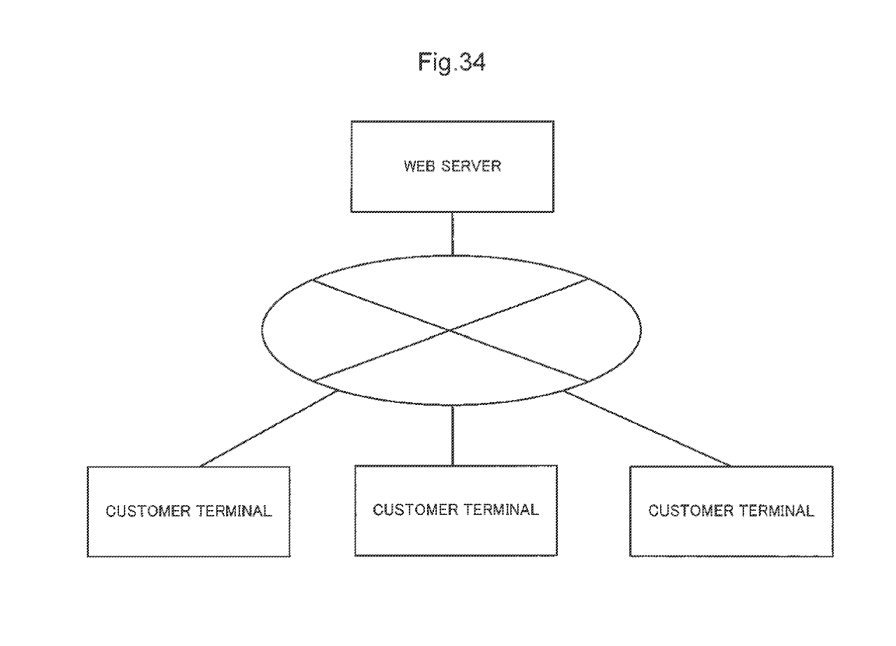

### DESCRIPTION OF EMBODIMENTS

Hereinafter, exemplary embodiments according to the present invention will be described in detail with reference to the drawings.

### First Exemplary Embodiment

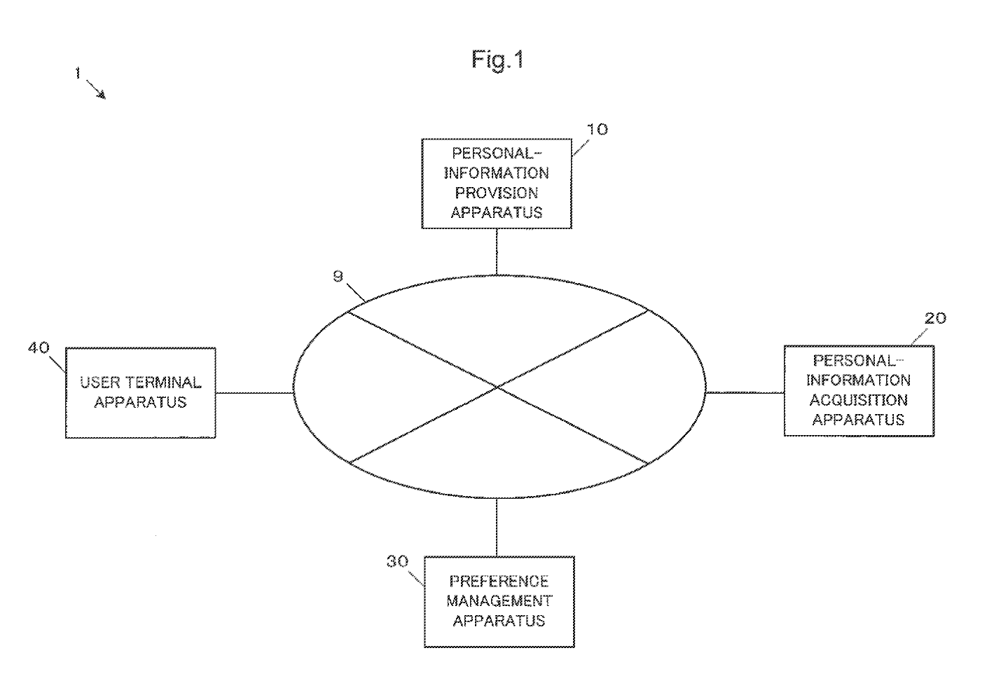

A configuration of a personal-information transmission/reception system 1 as a first exemplary embodiment according to the present invention is illustrated in FIG. 1. In FIG. 1, the personal-information transmission/reception system 1 includes a personal-information provision apparatus 10, a personal-information acquisition apparatus 20, a preference management apparatus 30 and a user terminal 40. Further, these apparatuses are connected so as to be communicable with one another via a network 9 which is constituted of the Internet, a local area network (LAN), a public line network, a wireless communication network, a combination of any two or more of these networks, or the like.

The personal-information provision apparatus 10 is an apparatus which manages personal information related to users. Further, the personal-information provision apparatus 10 acquires a preference, which prescribes disclosure conditions necessary for providing personal information to different apparatuses, from the preference management apparatus 30. Further, the personal-information provision apparatus 10 provides the personal-information acquisition apparatus 20 with personal information based on the acquired preference.

The personal-information acquisition apparatus 20 is an apparatus which provides services based on personal information related to users. The personal-information acquisition apparatus 20 acquires, in response to a request for a service provision from the user terminal 40, personal information necessary therefore from the personal-information provision apparatus 10. Further, the personal-information acquisition apparatus 20 provides the user terminal 40 with the service based on the acquired personal information.

The preference management apparatus 30 is an apparatus which manages preferences each prescribing disclosure conditions with respect to personal information related to a user. The preference management apparatus 30 provides the personal-information provision apparatus 10 with a preference which prescribes disclosure conditions with respect to a disclosure of personal information from the personal-information provision apparatus 10 to the personal-information acquisition apparatus 20.

The user terminal 40 is a terminal which is operated by a user who becomes a subject of personal information. The user terminal 40 requests the personal-information acquisition apparatus 20 to provide a service based on personal information related to a user thereof.

Although, in FIG. 1, for the convenience of description, only one apparatus is illustrated for each of the apparatuses, but this illustration does not limit the number of each of the apparatuses according to an aspect of the present invention.

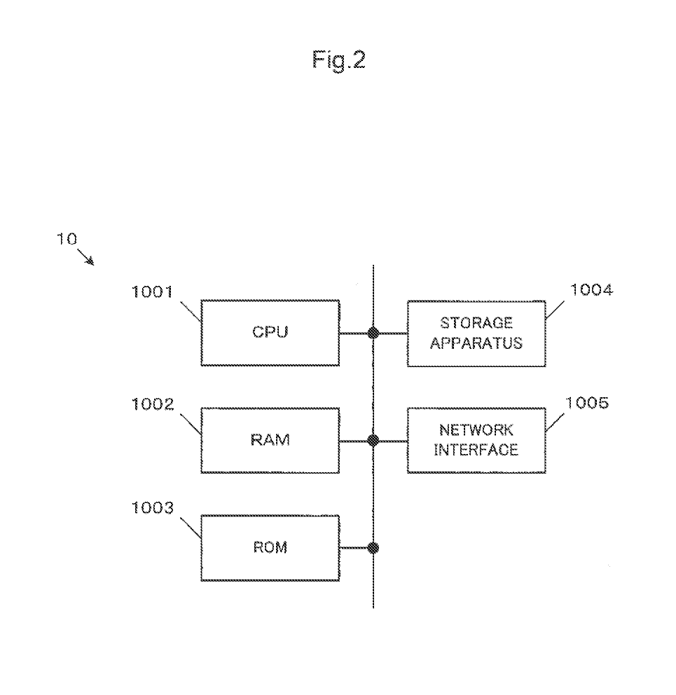

Next, a hardware configuration of each of the apparatuses constituting the personal-information transmission/reception system 1 is illustrated in FIGS. 2 to 5.

In FIG. 2, the personal-information provision apparatus 10 is a computer including, as hardware resources, a central processing unit (CPU) 1001, a random access memory (RAM) 1002, a read only memory (ROM) 1003, a storage apparatus 1004, such as a hard disk, and a network interface 1005.

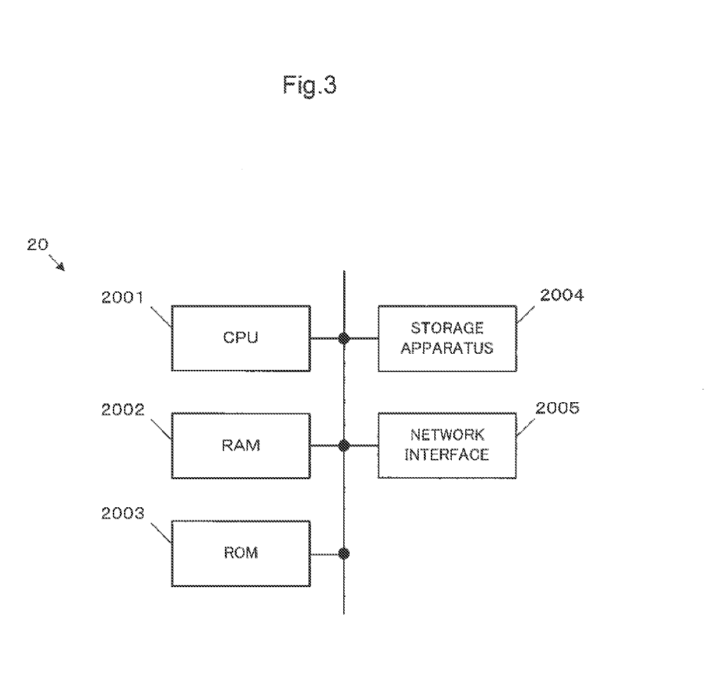

In FIG. 3, the personal-information acquisition apparatus 20 is a computer including, as hardware resources, a CPU 2001, a RAM 2002, a ROM 2003, a storage apparatus 2004, such as a hard disk, and a network interface 2005.

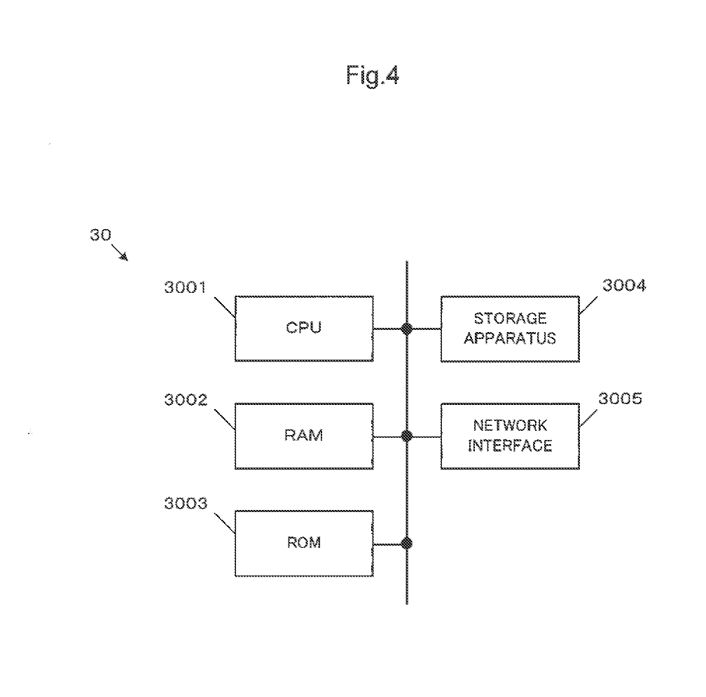

In FIG. 4, the preference management apparatus 30 is a computer including, as hardware resources, a CPU 3001, a RAM 3002, a ROM 3003, a storage apparatus 3004, such as a hard disk, and a network interface 3005.

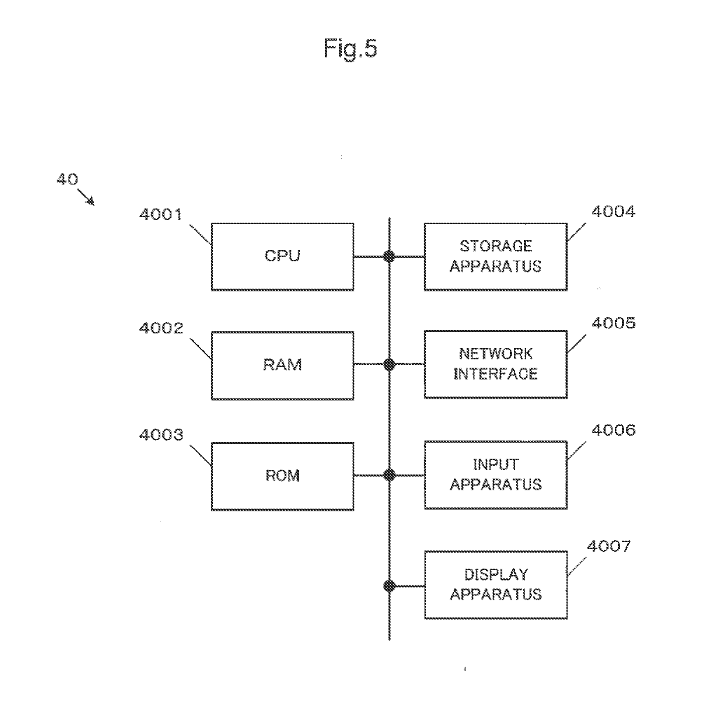

In FIG. 5, the user terminal 40 is a computer including, as hardware resources, a CPU 4001, a RAM 4002, a ROM 4003, a storage apparatus 4004, such as a hard disk, a network interface 4005, an input apparatus 4006 and a display apparatus 4007.

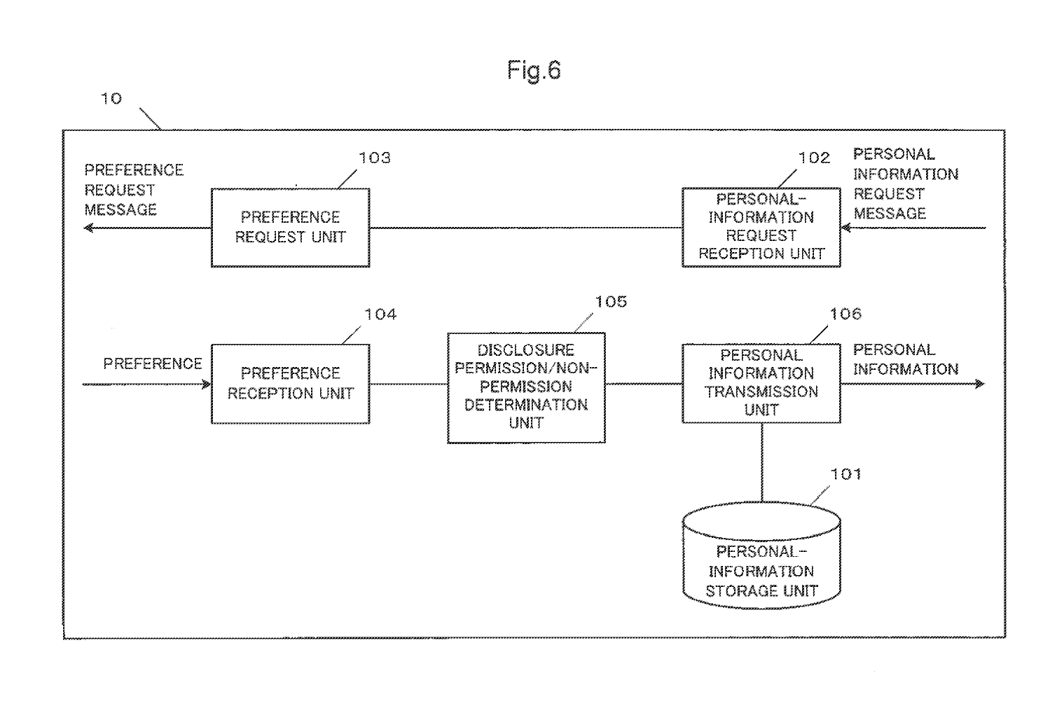

Next, a configuration of function blocks of the personal-information transmission/reception system 1 is illustrated in FIGS. 6 to 9.

In FIG. 6, the personal-information provision apparatus 10 includes a personal-information storage unit 101, a personal-information request reception unit 102, a preference request unit 103, a preference reception unit 104, a disclosure permission/non-permission determination unit 105 and a personal-information transmission unit 106.

Regarding the personal-information provision apparatus 10, relations between the hardware resources shown in FIG. 2 and the function blocks shown in FIG. 6 will be described. The personal-information storage unit 101 is constituted by the storage apparatus 1004. The personal-information request reception unit 102, the preference request unit 103, the preference reception unit 104 and the personal-information transmission unit 106 are realized by the CPU 1001, which reads corresponding computer programs (software programs) stored in the storage apparatus 1004 or the ROM 1003 into the RAM 1002 and executes them, and the network interface 1005. Further, the disclosure permission/non-permission determination unit 105 is realized by the CPU 1001, which reads a corresponding computer program stored in the storage apparatus 1004 or the ROM 1003 into the RAM 1002 and executes it.

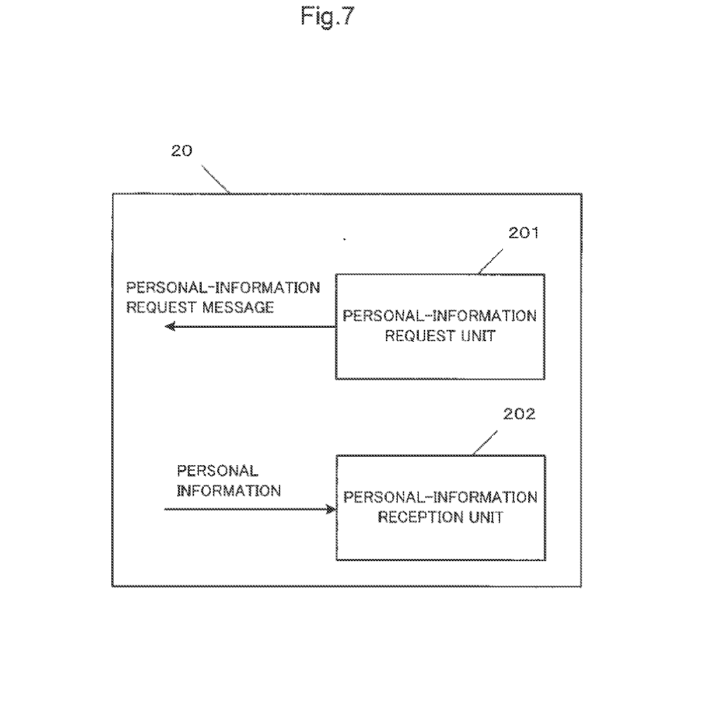

In FIG. 7, the personal-information acquisition apparatus 20 includes a personal-information request unit 201 and a personal-information reception unit 202. Regarding the personal-information acquisition apparatus 20, relations between hardware resources shown in FIG. 3 and function blocks shown in FIG. 7 will be described. The personal-information request unit 201 and the personal-information reception unit 202 are realized by the CPU 2001, which reads corresponding computer programs stored in the storage apparatus 2004 or the ROM 2003 into the RAM 2002 and executes them, and the network interface 2005.

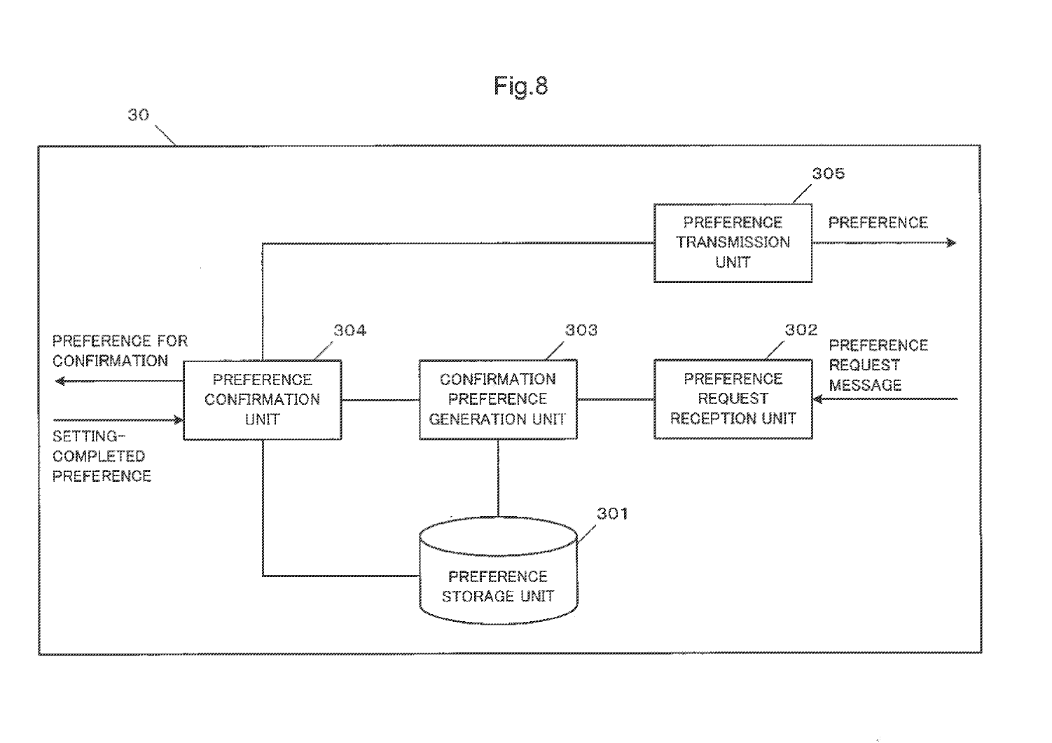

In FIG. 8, the preference management apparatus 30 includes a preference storage unit 301, a preference request reception unit 302, a confirmation preference generation unit 303, a preference confirmation unit 304 and a preference transmission unit 305. Regarding the preference management apparatus 30, relations between the hardware resources shown in FIG. 4 and the function blocks shown in FIG. 8 will be described. The preference storage unit 301 is realized by the storage apparatus 3004. Further, the preference request reception unit 302, the preference confirmation unit 304 and the preference transmission unit 305 are realized by the CPU 3001, which reads corresponding computer programs stored in the storage apparatus 3004 or the ROM 3003 into the RAM 3002 and executes them, and the network interface 3005. Further, the confirmation preference generation unit 303 is realized by the CPU 3001 which reads a corresponding computer program stored in the storage apparatus 3004 or the ROM 3003 into the RAM 3002 and executes it.

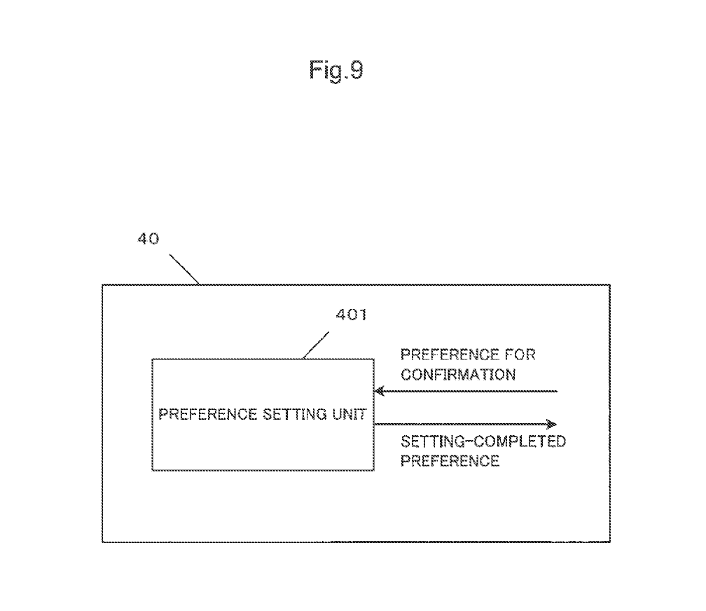

In FIG. 9, the user terminal 40 includes a preference setting unit 401. Regarding the user terminal 40, relations between the hardware resources shown in FIG. 5 and the function blocks shown in FIG. 9 will be described. The preference setting unit 401 is realized by the CPU 4001, which reads a corresponding computer program stored in the storage apparatus 4004 or the ROM 4003 into the RAM 4002 and executes it, the network interface 4005, the input apparatus 4006 and the display apparatus 4007.

It is noted that the hardware configurations forming the function blocks of the respective apparatuses are not limited to the aforementioned configurations.

Next, each of the function blocks of the personal-information provision apparatus 10 will be described by using FIG. 6. The personal-information storage unit 101 stores personal information. For example, the personal-information storage unit 101 may store, as personal information, pieces of information to each of which a user ID for identifying a user who becomes a subject of personal information, a kind of the personal information and the content of the personal information are associated (are correlated). Here, the kind of personal information means a kind of a piece of information representing a personal attribute, such as a name, an address, a telephone number or a credit-card number.

The personal-information request reception unit 102 receives a personal information request message RM1 from the personal-information acquisition apparatus 20. For example, the personal information request message RM1 may include pieces of information which represent a user ID of a user who is a subject of requested personal information; a kind of the personal information; utilization conditions representing a purpose, a utilization scope and the like in the case where the personal-information acquisition apparatus 20 utilizes the personal information; and an apparatus ID for identifying the personal-information acquisition apparatus 20 which is a request source, respectively.

In response to the reception of the personal information request message RM1, the preference request unit 103 transmits a preference request message RM2, which requests a preference prescribing disclosure conditions with respect to requested personal information, to the preference management apparatus 30. For example, the preference request message RM2 may include pieces of information which represent a user ID of a user who becomes a subject of requested personal information; a kind of the personal information; a utilization conditions with respect to the personal information in the personal-information acquisition apparatus 20; disclosure conditions with respect to disclosures of the personal information from the apparatus itself to different apparatuses; an apparatus ID of the personal-information acquisition apparatus 20 which is a request source; and an apparatus ID for identifying the personal-information provision apparatus 10 which is the apparatus itself, respectively.

Here, the disclosure conditions with respect to disclosures of personal information from the apparatus itself to different apparatuses may include a communication protocol for use in the provision of the personal information from the personal-information provision apparatus 10 to the personal-information acquisition apparatus 20, and the like.

The preference reception unit 104 acquires preferences from the preference management apparatus 30. For example, the preference may include a user ID, a kind of personal information; a handling condition with respect to the personal information; an apparatus ID of the personal-information provision apparatus 10, an apparatus ID of the personal-information acquisition apparatus 20, a result of a permission confirmation (permission or non-permission with respect to a relevant disclosure) having been performed by a user, a validity period and the like.

For example, the handling condition with respect to personal information may include pieces of information which represents a utilization purpose of personal information in the personal-information acquisition apparatus 20, a holding period, the presence or absence of a provision to a third party, a management method and the like. Further, in the handling condition with respect to personal information, for example, as a communication protocol for use in disclosing the personal information, a condition stating that “personal information shall be transmitted by means of Secure Socket Layer (SSL) communication”, or the like, may be included.

The disclosure permission/non-permission determination unit 105 determines whether or not it is possible to disclose personal information having been requested by the personal-information acquisition apparatus 20 to the personal-information acquisition apparatus 20, based on a preference having been received by the preference reception unit 104.

Specifically, the disclosure permission/non-permission determination unit 105 determines whether or not it is possible to disclose personal information having been requested thereby, based on whether or not information representing disclosure permission is included in the acquired preference. The disclosure permission/non-permission determination unit 105 may determine whether or not it is possible to disclose personal information having been requested thereby, by comparing a handling condition with respect to the personal information, which is included in the acquired preference, with a utilization condition included in the personal information request message RM1. Moreover, the disclosure permission/non-permission determination unit 105 may determine whether or not it is possible to disclose personal information having been requested thereby, by verifying a validity period included in the acquired preference.

When it has been determined by the disclosure permission/non-permission determination unit 105 that it is possible to disclose the relevant personal information, the personal-information transmission unit 106 transmits the personal information to the personal-information acquisition apparatus 20 which is a request source.

Next, individual function blocks of the personal-information acquisition apparatus 20 will be described by using FIG. 7.

The personal-information request unit 201 transmits the personal information request message RM1, which requests a provision of personal information necessary for a service provision requested by the user terminal 40, to the personal-information provision apparatus 10. For example, it is assumed that the personal-information acquisition apparatus 20 needs a mail address of a user A for a service provision, and, as a utilization condition with respect to personal information to be acquired, the personal-information acquisition apparatus 20 sets a condition such as “providing information related to a product”. In this case, the personal-information request unit 201 writes “a user ID: A, a kind of user information: a mail address, a utilization purpose: to provide information related to a product, and an apparatus ID of a personal-information acquisition apparatus: 0001” into the personal information request message RM1, and transmits it to the personal-information provision apparatus 10.

The personal-information reception unit 202 receives personal information from the personal-information provision apparatus 10.

Next, individual function blocks of the preference management apparatus 30 will be described by using FIG. 8.

The preference storage unit 301 stores preferences having been set before now by the user terminal 40. For example, the preference storage unit 301 may store preferences each including a user ID, a kind of personal information, a handling condition with respect to the personal information, an apparatus ID of the personal-information acquisition apparatus 20, an apparatus ID of the personal-information provision apparatus 10, a result of a permission confirmation (permission or non-permission of a disclosure) having been performed by a user, a validity period and the like.

The preference request reception unit 302 receives the preference request messages RM2 from the personal-information provision apparatus 10.

The confirmation preference generation unit 303 generates a confirmation preference CP to be presented to the user terminal 40 based on the past preferences stored in the preference storage unit 301 as well as the preference request message RM2 received from the personal-information provision apparatus 10. For example, the confirmation preference generation unit 303 may generate a confirmation preference CP based on a preference which is among the preferences stored in preference storage unit 301, and which includes the same information as at least part of information included in the preference request message RM2.

In this case, specifically, the confirmation preference generation unit 303 searches the preference storage unit 301 for a preferences including a user ID and a kind of personal information which are the same as those included in the preference request message RM2. When an appropriate preference has been searched for, the confirmation preference generation unit 303 generates a preference, as the confirmation preference CP, which results from applying an apparatus ID of the personal-information provision apparatus 10 and an apparatus ID of the personal-information acquisition apparatus 20, which are included in the preference request message RM2, to the past preference having been searched for.

In other words, for example, the confirmation preference generation unit 303 may generate a confirmation preference CP based on a preference, in which, with respect to personal information of the same kind as that of requested personal information, a disclosure condition on a personal-information acquisition apparatus 20 other than the personal-information acquisition apparatus 20 which is a request source was prescribed by the same user as a user who becomes a subject of the requested personal information.

Moreover, the confirmation preference generation unit 303 may generate a confirmation preference CP which reflects the contents of the preference request message RM2 just as they are.

The preference confirmation unit 304 presents the confirmation preferences CPs described above to the user terminal 40, and receives a preference, which has been set based on the presented confirmation preferences CPs, from user terminal 40. The preference confirmation unit 304 may receive a preference in which only an agreement or a disagreement with respect to the presented confirmation preferences CPs is set. Further, the preference confirmation unit 304 may receive a preference in which part of or the whole of the presented confirmation preferences CP is customized and set.

For example, it is assumed a case where a confirmation preference A which is a confirmation preference CP based on the past preference, and a confirmation preference B which reflects the contents of the preference request message RM2 just as they are, are generated by the confirmation preference generation unit 303. In this case, the preference confirmation unit 304 transmits the two preferences A and B to the user terminal 40 to present them. Further, in this case, the preference confirmation unit 304 acquires information representing which one of the confirmation preferences A and B was permitted by the user, or information representing the contents of customization on part of or the whole of any one of the confirmation preferences A and B, from the user terminal 40.

In the case where information representing that the confirmation preference A was permitted has been acquired, as a result, the preference confirmation unit 304 has acquired information, which results from adding information representing a disclosure permission to the confirmation preference A based on the past preference, as a setting-completed preference.

Alternatively, in the case where information representing that the confirmation preference B was permitted has been acquired, as a result, the preference confirmation unit 304 has acquired an information set, which results from adding information representing a disclosure permission to the confirmation preference B which reflects the contents of the preference request message RM2 just as they are, as a setting-completed preference.

Alternatively, in the case where information representing the contents of customization has been acquired, as a result, the preference confirmation unit 304 has acquired an information set, which results from applying the contents of customization to the contents of the confirmation preference A or the confirmation preference B, as a setting-completed preference.

Further, the preference confirmation unit 304 stores the received setting-completed preference into the preference storage unit 301.

The preference transmission unit 305 transmits the setting-completed preference having been received by the preference confirmation unit 304 to the personal-information provision apparatus 10.

In addition, only when it can be determined that it is possible to provide the personal information from the personal-information provision apparatus 10, which requested the preference, to the personal-information acquisition apparatus 20, which is a request source of the personal information, the preference transmission unit 305 should transmit the preference to the personal-information provision apparatus 10. In this case, when the preference transmission unit 305 has determined that it is not possible to provide the personal information from the relevant personal-information provision apparatus 10 to the relevant personal-information acquisition apparatus 20, the preference transmission unit 305 should transmit an error message.

Next, individual function blocks of the user terminal 40 will be described by using FIG. 9. The preference setting unit 401 performs setting of a preference with respect to the provision of personal information from the personal-information provision apparatus 10 to the personal-information acquisition apparatus 20 based on the above-described confirmation preferences CPs presented by the preference management apparatus 30. Further, the preference setting unit 401 transmits the setting-completed preference to the preference management apparatus 30.

Specifically, the preference setting unit 401 indicates the above-described confirmation preferences CPs presented by the preference management apparatus 30 on the display apparatus 4007. Further, the preference setting unit 401 acquires a setting content based on the confirmation preferences CPs via the input apparatus 4006. The setting content based on the confirmation preferences CPs is, for example, information representing which one of a plurality of confirmation preferences CPs has been permitted, or information representing the contents of customization on part of or the whole of any one the confirmation preferences CPs. Further, the preference setting unit 401 transmits the setting content having been acquired via the input apparatus 4006 to the preference management apparatus 30.

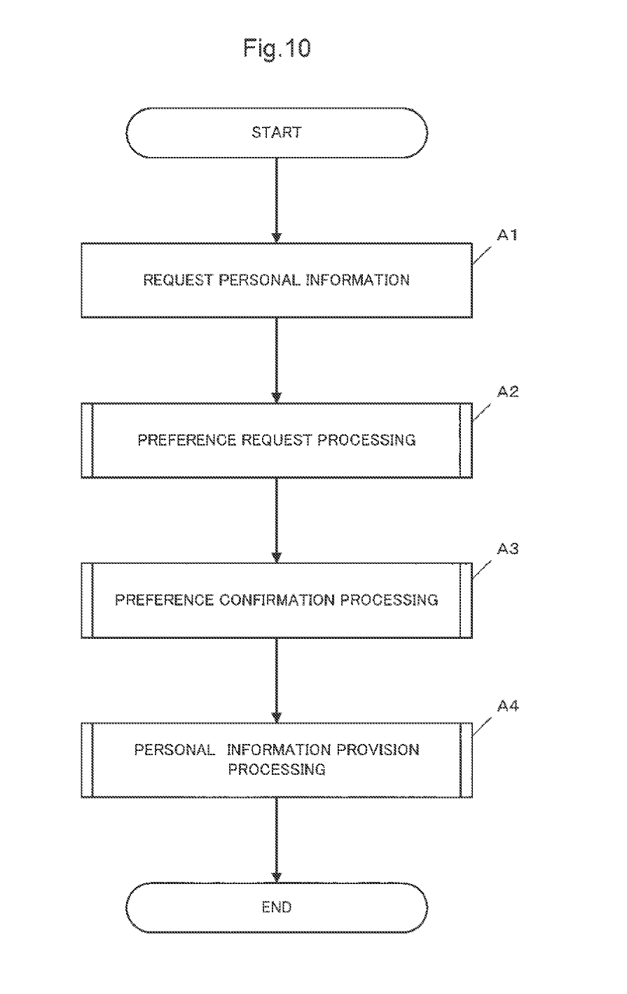

Operation of the personal-information transmission/reception system 1 having such a configuration as described above will be described with reference to flowcharts shown in FIGS. 10 to 13.

FIG. 10 is a flowchart illustrating an outline of personal information transmission/reception operation of the personal-information transmission/reception system 1. In FIG. 10, first, the personal-information acquisition apparatus 20 transmits the personal information request message RM1 to the personal-information provision apparatus 10 (step A1).

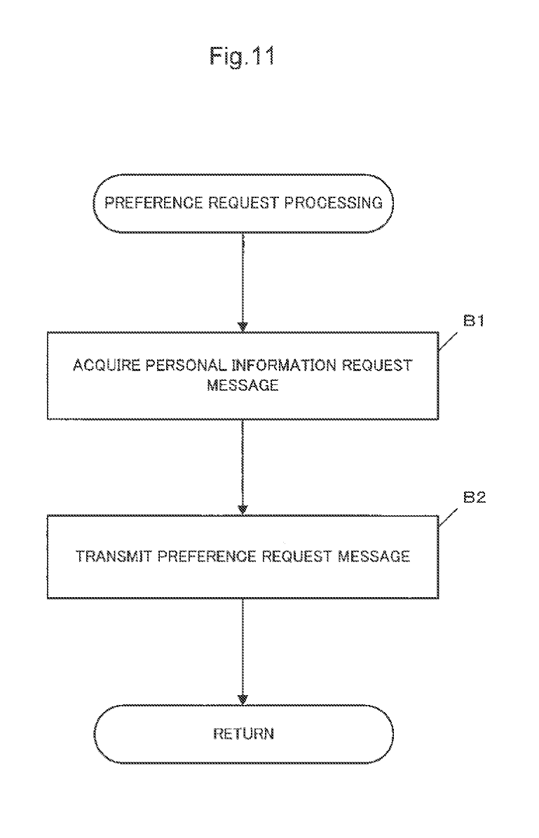

Next, the personal-information provision apparatus 10, which has received the personal information request message RM1, transmits the preference request message RM2 for requesting a preference in accordance with the personal information request message RM1, to the preference management apparatus 30 (step A2). The details of preference request processing performed in step A2 above will be described below with reference to FIG. 11.

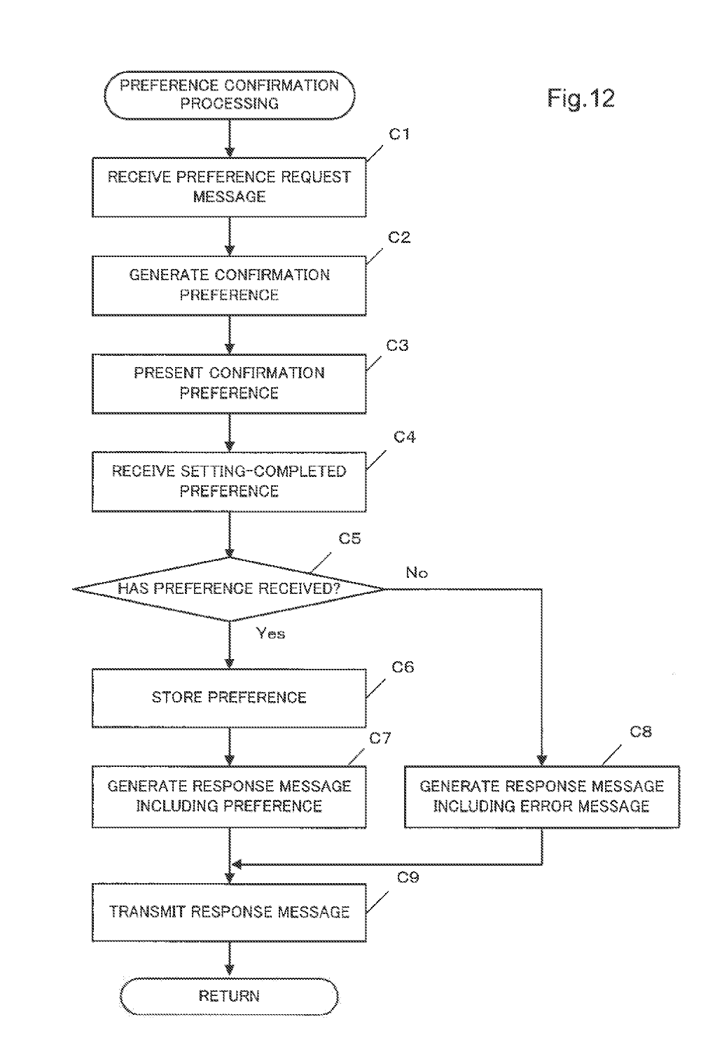

Next, the preference management apparatus 30, which has received the preference request message RM2, acquires a setting-completed preference by confirming the confirmation preferences CPs with the user terminal 40. Further, the preference management apparatus 30 transmits the acquired preference to the personal-information provision apparatus 10 (step A3). The details of preference confirmation processing performed in step A3 above will be described below with reference to FIG. 12.

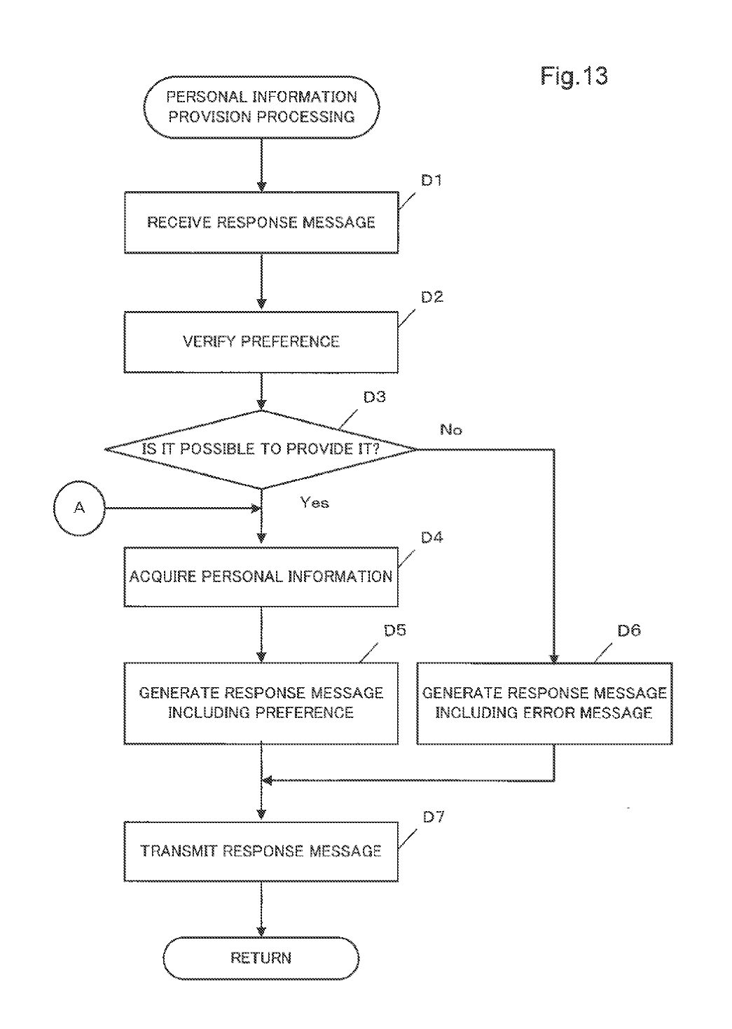

Next, in the case where the personal-information provision apparatus 10, which has acquired the preference, is able to determine that it is possible to provide relevant personal information to the personal-information acquisition apparatus 20, based on the content of the acquired preference, the personal-information provision apparatus 10 reads out the relevant personal information from the personal information stored in the personal-information storage unit 101, and transmits it to the personal-information acquisition apparatus 20 (step A4). The details of the personal information provision processing performed in step A4 above will be described below with reference to FIG. 13.

This is the end of description of the outline of personal information transmission/reception operation of the personal-information transmission/reception system 1.

Next, the preference request processing of the personal-information provision apparatus 10 in step A2 will be described by using the flowchart shown in FIG. 11. The preference request processing shown in FIG. 11 illustrates a processing procedure which is realized by causing the CPU 1001 of the personal-information provision apparatus 10 to execute a corresponding computer program by using the hardware resources shown in FIG. 2.

First, in the personal-information provision apparatus 10, the personal-information request reception unit 102 receives the personal information request message RM1 from the personal-information acquisition apparatus 20 (step B1). This personal information request message RM1 may include, for example, a user ID which is a subject of requested personal information, a kind of the personal information, a utilization condition with respect to the personal information, such as a utilization purpose and a utilization scope, an apparatus ID of the personal-information acquisition apparatus 20 which is a request source, and the like.

Next, the preference request unit 103 generates the preference request message RM2 based on the personal information request message RM1 having been received in step SB1, and transmits the generated preference request message RM2 to the preference management apparatus 30 (step B2). This preference request message RM2 may include, for example, a disclosure condition to allow the personal-information provision apparatus 10 to disclose personal information to the personal-information acquisition apparatus 20, an apparatus ID of the personal-information provision apparatus 10 and the like, in addition to the various pieces of information included in the personal information request message RM1.

This is the end of description of the preference request processing in step A2 of FIG. 10.

Next, the preference confirmation processing of the preference management apparatus 30 in step A3 will be described by using the flowchart shown in FIG. 12. The preference confirmation processing shown in FIG. 12 illustrates a processing procedure which is realized by causing the CPU 3001 of the preference management apparatus 30 to execute a corresponding computer program by using the hardware resources shown in FIG. 4.

First, in the preference management apparatus 30, the preference request reception unit 302 receives the preference request message RM2 from the personal-information provision apparatus 10 (step C1). In this preference request message RM2, as described above, for example, a user ID which is a subject of requested personal information, utilization conditions and disclosure conditions in the personal-information provision apparatus 10 and the personal-information acquisition apparatus 20, an apparatus ID of the personal-information provision apparatus 10, an apparatus ID of the personal-information acquisition apparatus 20 and the like, are described.

Next, the confirmation preference generation unit 303 generates confirmation preferences CPs based on the past preference stored in the preference storage unit 301 and the preference request message RM2 (step C2). For example, the confirmation preference generation unit 303 generates a confirmation preference CP based on a preference including a user ID and a kind of personal information which are the same as those included in the preference request message RM2. Moreover, the confirmation preference generation unit 303 may generate a confirmation preference CP which reflects the contents of the preference request message RM2 just as they are.

In the case where any appropriate past preference is not stored in the preference storage unit 301, the confirmation preference generation unit 303 may generate only the confirmation preference CP which reflects the contents of the preference request message RM2 just as they are.

Next, the preference confirmation unit 304 presents the confirmation preferences CPs to the user terminal 40 (step C3). Next, the preference confirmation unit 304 receives a preference, which has been set based on the confirmation preferences CPs having been presented in step C3, from the user terminal 40 (step C4). At this time, the preference confirmation unit 304 may generate a setting-completed preference by acquiring, for example, information representing permission of any one of the confirmation preferences CPs having been presented in step C3, or setting contents resulting from customization on any one of the confirmation preferences CPs, and the like, and applying the acquired information or setting contents to the corresponding confirmation preference CP.

In the case where none of the confirmation preferences CPs is permitted, and is also customized, the confirmation preference generation unit 303 may regenerate confirmation preferences CPs in which utilization conditions and disclosure conditions are made stricter, and the preference confirmation unit 304 may perform reconfirmation processing targeted for the user terminal 40 by using the regenerated confirmation preferences CPs.

Further, in the case where none of the confirmation preferences CPs is permitted, and is also customized, the preference confirmation unit 304 determines this event as an event in which any setting-completed preference could not be received.

In the case where the preference confirmation unit 304 has received a setting-completed preference (“Yes” in step C5), the preference confirmation unit 304 registers the received preference into the preference storage unit 301 (step C6). Then, the preference transmission unit 305 generates a response message including the received preference (step C7).

In contrast, in the case where the preference confirmation unit 304 could not receive any setting-completed preference (“No” in step C5), the preference transmission unit 305 generates a response message including an error notice (step C8). Next, the preference transmission unit 305 transmits the response message having been generated in step C7 or step C8 to the personal-information provision apparatus 10 (step C9).

This is the end of description of the preference confirmation processing in step A3.

Next, the personal information provision processing of the personal-information provision apparatus 10 in step A4 will be described by using the flowchart shown in FIG. 13. The personal information provision processing shown in FIG. 13 illustrates a processing procedure which is realized by causing the CPU 1001 of the personal-information provision apparatus 10 to execute a corresponding computer program by using the hardware resources shown in FIG. 2.

First, in the personal-information provision apparatus 10, the preference reception unit 104 acquires a response message from the preference management apparatus 30 (step D1). Next, the disclosure permission/non-permission determination unit 105 verifies a preference included in the acquired response message (step D2).

For example, the disclosure permission/non-permission determination unit 105 verifies the following matters and the like:
whether or not a preference is included in the response message;
whether or not utilization conditions included in the personal information request message RM1 satisfies handling conditions included in the preference included in the response message;
whether or not information representing disclosure permission is included; and
a validity period included in the preference.

Next, the disclosure permission/non-permission determination unit 105 determines whether or not it is possible to provide the personal information from the personal-information provision apparatus 10 to the personal-information acquisition apparatus 20, based on the verification result (step D3). If it is determined that it is possible to provide the personal information, the personal-information transmission unit 106 acquires the relevant personal information from the personal-information storage unit 101 (step D4). Next, the personal-information transmission unit 106 generates a response message including the personal information having been acquired in step D4 (step D5).

In contrast, it is determined in step D3 that it is not possible to provide the personal information from the personal-information provision apparatus 10 to the personal-information acquisition apparatus 20, the personal-information transmission unit 106 generates a response message including an error notice (step D6).

Next, the personal-information transmission unit 106 transmits the response message having been generated in step D5 or step D6 to the personal-information acquisition apparatus 20 (step D7).

This is the end of description of the personal information processing in step A4.

In addition, in step C5 of FIG. 12, in the case where the preference management apparatus 30 has determined that a preference has been received, the preference management apparatus 30 may further determine whether or not it is possible to provide the private information from the personal-information provision apparatus 10 to the personal-information acquisition apparatus 20, based on the received preference. As a result, the preference management apparatus 30 and the personal-information provision apparatus 10 performs disclosure permission/non-permission determination processing in step C5 and in step D3, respectively, thereby enabling increase of certainty of the disclosure permission/non-permission determination.

Further, in step C2 of FIG. 12, in the case where a preference, which represents that information included in the preference request message RM2 is permitted, is stored in the preference storage unit 301, the preference management apparatus 30 may omit the processes in steps C2 to C6. In this case, the preference management apparatus 30 acquires the relevant preference from the preference storage unit 301, and carries out the processes in steps C7 and C8 on the acquired preference. As a result, it is possible to omit the processing for confirming a preference with the user terminal 40.

Next, advantageous effects of the first embodiment according to the present invention will be described.

Even when the number of apparatuses retaining personal information has increased, the personal-information transmission/reception system according to the first embodiment can reduce (suppress to a minimum) the burden of a user who sets preferences with respect to disclosures of personal information.

A reason of this is that the preference management apparatus 30 acquires a preference from the user terminal 40 with respect to a disclosure of personal information from the personal-information provision apparatus 10 to the personal-information acquisition apparatus 20, and the personal-information provision apparatus 10 provides the personal information to the personal-information acquisition apparatus 20 based on the preference which the preference management apparatus 30 has acquired from the user terminal 40.

That is, since, in the personal-information transmission/reception system as the first embodiment, the preference management apparatus 30 performs centralized management of preferences, a user does not need to set preferences with respect to disclosures of personal information for each of apparatuses possessing the personal information. According to this embodiment, therefore, it is possible to reduce the burden of a user who sets preferences with respect to disclosures of personal information.

Moreover, a further reason why it is possible to receive the above-described advantageous effects associated with this embodiment is that the confirmation preference generation unit 303 of the preference management apparatus 30 generates a confirmation preference CP based on the past preference stored in the preference storage unit 301, and presents the generated confirmation preference CP to the user terminal 40. For this reason, a user can easily confirm the preference having been set in the past, so that, with respect to disclosures of personal information in a plurality of apparatuses possessing personal information, it becomes easy to set a plurality of preferences such that the preferences are not inconsistent with one another.

### Second Exemplary Embodiment

Next, a second exemplary embodiment based on the aforementioned first exemplary embodiment according to the present invention will be described in detail with reference to the drawings. In each of drawings referred to in description of this embodiment, components which are the same as those of the first embodiment according to the present invention, as well as steps which operate in ways similar to those thereof, are denoted by the same reference signs, and detailed description thereof in this embodiment will be omitted.

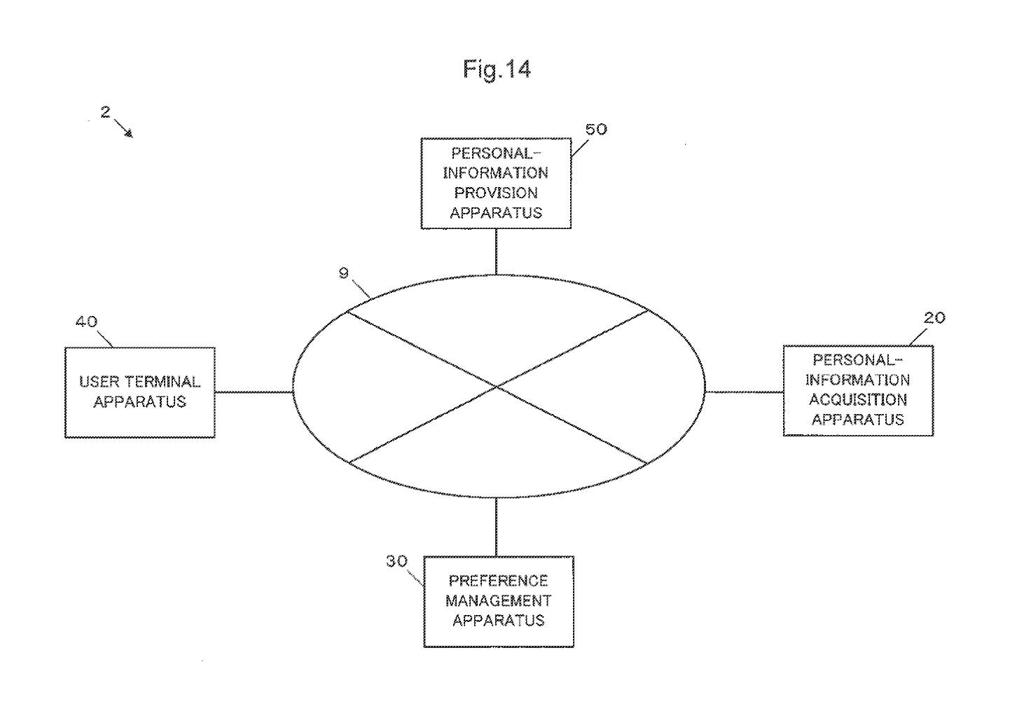

First, a configuration of a personal-information transmission/reception system 2 as this second embodiment is illustrated in FIG. 14. In FIG. 14, as compared with the personal-information transmission/reception system 1 in the first embodiment, the personal-information transmission/reception system 2 is different from the above in the configuration in which a personal-information provision apparatus 50 is included therein as substitute for the personal-information provision apparatus 10. In this embodiment, it is assumed that the personal-information provision apparatus 50 includes the same hardware resources as those of the personal-information provision apparatus 10 shown in FIG. 2.

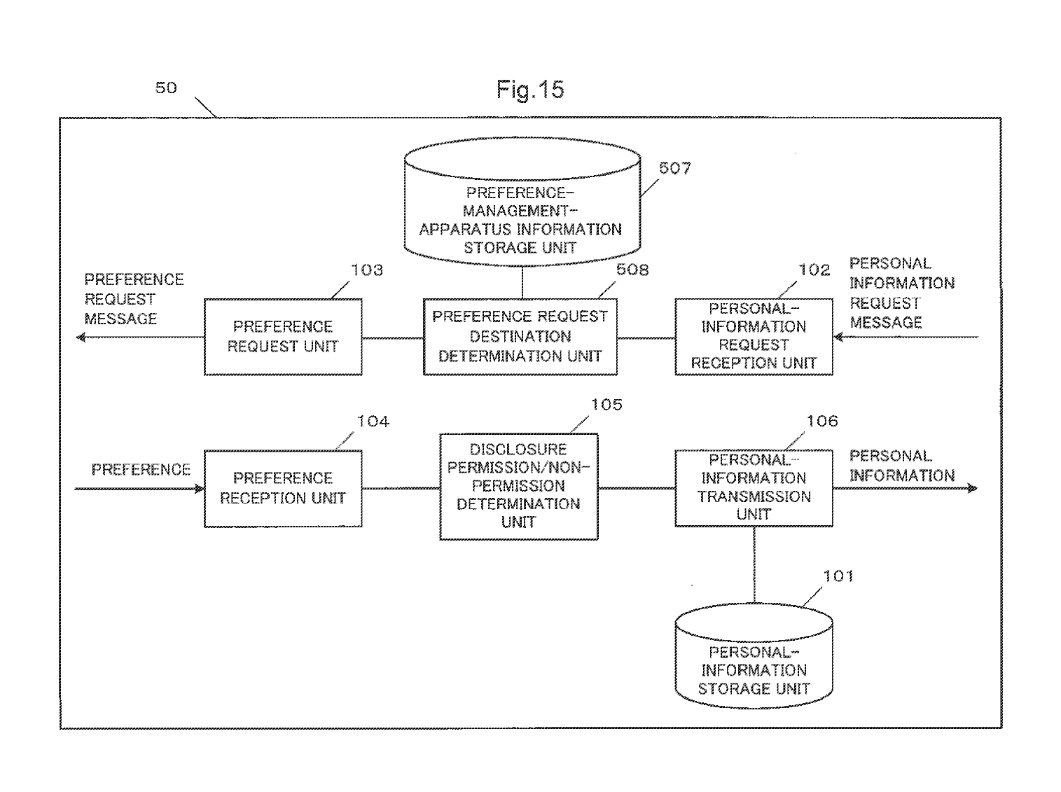

A configuration of function blocks of the personal-information provision apparatus 50 is illustrated in FIG. 15. In FIG. 15, as compared with the personal-information provision apparatus 10 in the first embodiment, the personal-information provision apparatus 50 is different from the above in the configuration in which a preference-management-apparatus information storage unit 507 and a preference request destination determination unit 508 are further included therein.

The preference-management-apparatus information storage unit 507 stores pieces of information each representing a preference management apparatus 30. For example, the preference-management-apparatus information storage unit 507 may store pieces of information each resulting from correlating the following pieces of information with one another: a user ID for identifying a user who is a subject of personal information; an apparatus ID for identifying a preference management apparatus 30 which manages a preference to be set by a user having the user ID; and a URL of a transmission destination of the preference request message RM2.

The preference request destination determination unit 508 determines a preference management apparatus 30, which becomes a transmission destination of the preference request message RM2 in accordance with the personal information request message RM1 having been received by the personal-information request reception unit 102, based on the preference-management-apparatus information storage unit 507. For example, the preference request destination determination unit 508 may determine a preference management apparatus 30 corresponding to an apparatus ID which is associated with a user ID included in the personal information request message RM1, as the transmission destination of the preference request message RM2.

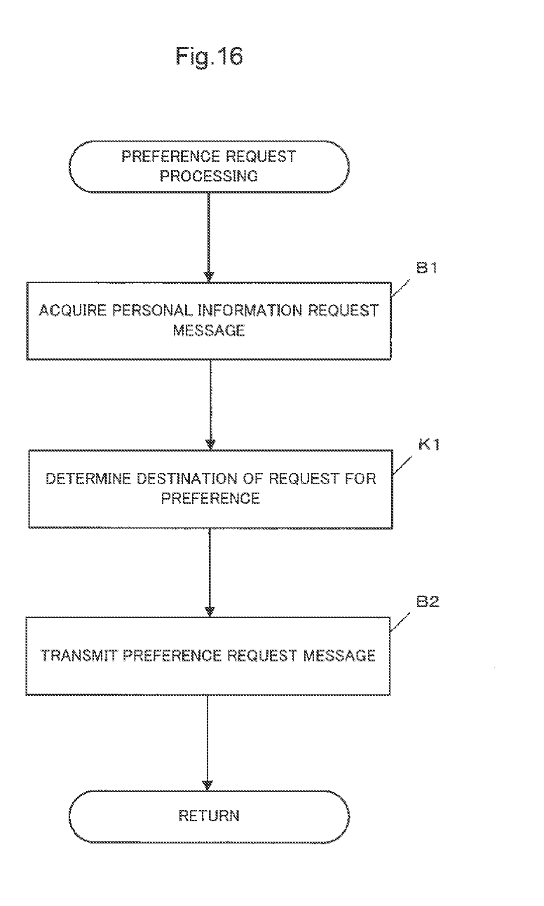

Preference request processing of the personal-information transmission/reception system 2 which is configured in such a way as described above will be described with reference to FIG. 16. Preference request processing shown in FIG. 16 illustrates a processing procedure which is realized by the CPU 1001 of the personal-information provision apparatus 50 to execute a corresponding computer program by using the hardware resources shown in FIG. 2. In addition, since the outline of personal information transmission/reception operation, preference confirmation processing and personal information provision processing of the personal-information transmission/reception system 2 are similar to those of the personal-information transmission/reception system 1 as the first embodiment, which has been described above with reference to FIGS. 10, 12 and 13, description thereof in this embodiment will be omitted.

In FIG. 16, first, the personal-information request reception unit 102 of the personal-information provision apparatus 50 receives the personal information request message RM1 from the personal-information acquisition apparatus 20 (step B1). Next, the preference request destination determination unit 508 refers to the preference-management-apparatus information storage unit 507, and thereby determines a preference management apparatus 30 to which the preference request message RM2 in accordance with the personal information request message RM1 having been received in step B1 is to be transmitted (step K1).

For example, the preference request destination determination unit 508 acquires an apparatus ID of a preference management apparatus 30, which is associated with a user ID described in the personal information request message RM1, as well as a transmission-destination URL of the preference management apparatus 30.

Next, the preference request unit 103 generates the preference request message RM2, and transmits it to a request destination having been determined in step K1 (step B2).

This is the end of description of the preference request processing.

Next, advantageous effect of the second embodiment according to the present invention will be described.

The personal-information transmission/reception system 2 according to the second embodiment can further reduce the burden of a user who sets preferences with respect to disclosures of personal information. A reason of this is that the personal-information provision apparatus 50 stores information related to preference management apparatuses 30s in advance, and determines a request destination for a preference in accordance with the personal information request message RM1, based on the stored information. For this reason, when generating a confirmation preference CP to be presented to the user terminal 40, the personal-information transmission/reception system 2 according to this embodiment can select a further suitable preference, as a preference to be referred to, from among preferences managed by a plurality of preference management apparatuses 30s.

### Third Exemplary Embodiment

Next, a third exemplary embodiment based on the aforementioned first and second exemplary embodiments will be described in detail with reference to the drawings. In addition, in each of drawings referred to in description of this embodiment, components which are the same as those of the first and second embodiments, as well as steps which operate in ways similar to those thereof, are denoted by the same reference signs, and detailed description thereof in this embodiment will be omitted.

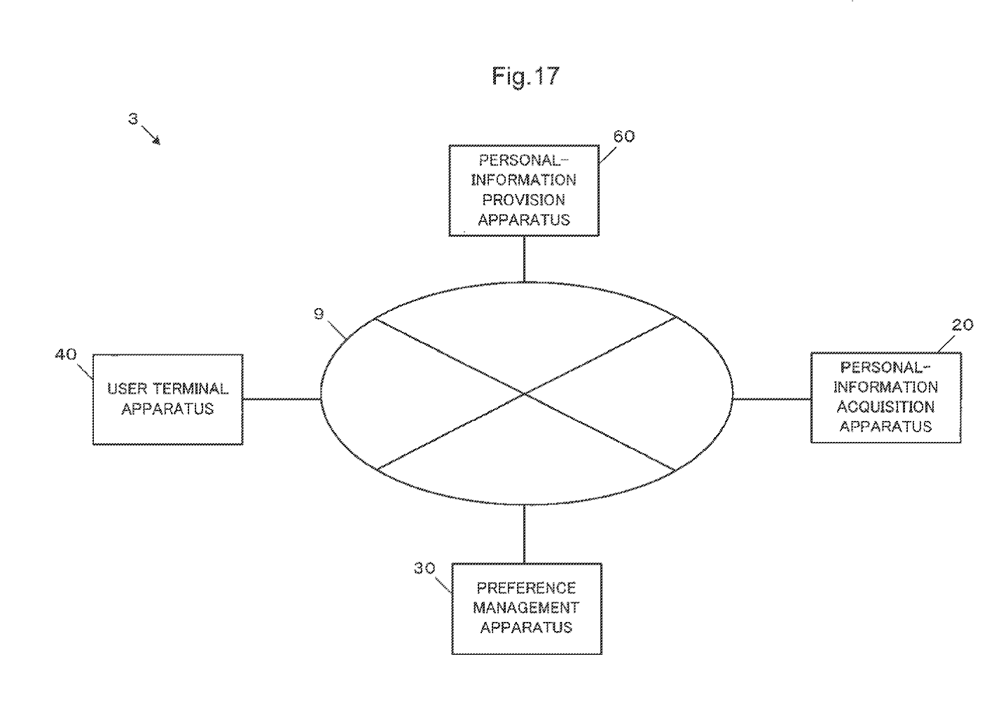

First, a configuration of a personal-information transmission/reception system 3 according to this third embodiment is illustrated in FIG. 17. In FIG. 17, as compared with the personal-information transmission/reception system 2 in the second embodiment, the personal-information transmission/reception system 3 is different from the above in the configuration in which a personal-information provision apparatus 60 is included as substitute for the personal-information provision apparatus 50. In this embodiment, it is assumed that the personal-information provision apparatus 60 includes the same hardware resources as those of the personal-information provision apparatus 10 shown in FIG. 2.

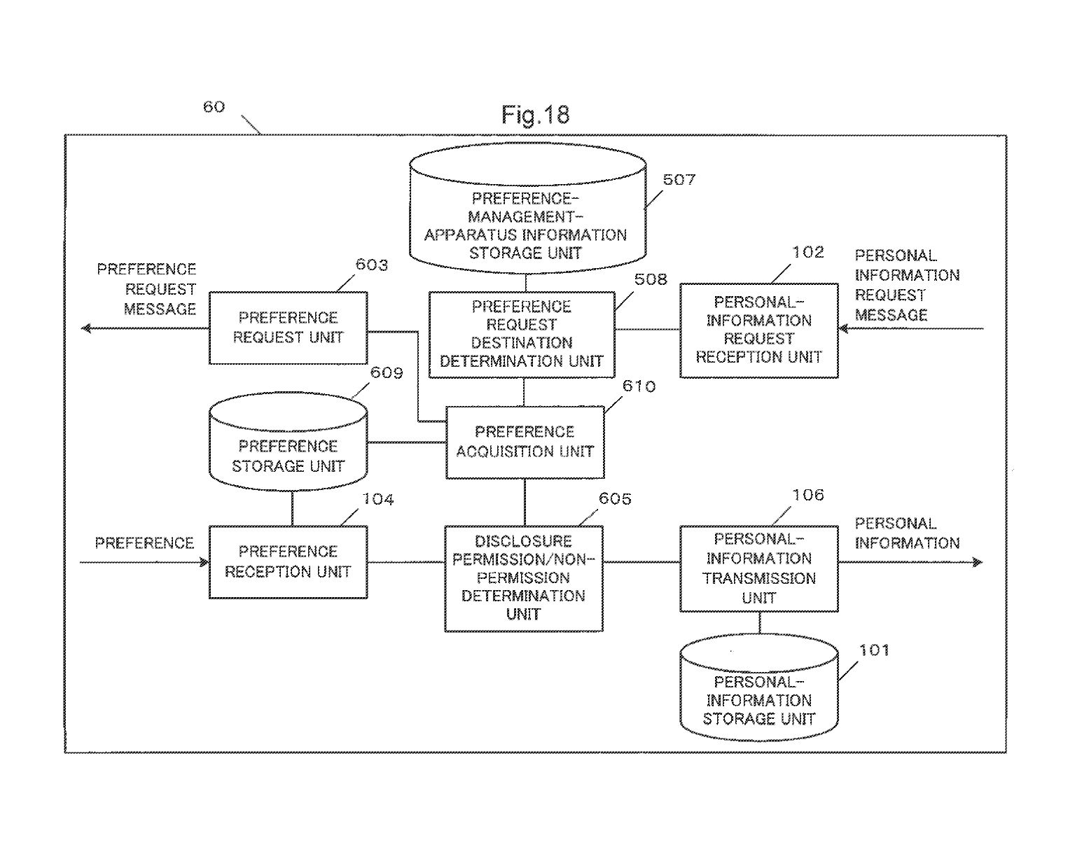

A configuration of function blocks of the personal-information provision apparatus 60 is illustrated in FIG. 18. In FIG. 18, as compared with the personal-information provision apparatus 50 in the first and second embodiments, the personal-information provision apparatus 60 is different from the above in the configuration in which a preference request unit 603 and a disclosure permission/non-permission determination unit 605 are included therein as substitute for the preference request unit 103 and the disclosure permission/non-permission determination unit 105, respectively, and a preference storage unit 609 and a preference acquisition unit 610 are further included therein.

The preference storage unit 609 stores preferences which the preference reception unit 104 has acquired from the preference management apparatus 30. In the case where a preference with respect to providing personal information, which is requested by the personal information request message RM1, from the personal-information provision apparatus 60 to the personal-information acquisition apparatus 20 is stored in the preference storage unit 609, the preference acquisition unit 610 acquires the preference stored in the preference storage unit 609.

For example, the preference acquisition unit 610 determines whether or not a preference including the same information as that included in the personal information request message RM1 is stored in the preference storage unit 609, the information being a user ID, a kind of personal information, a utilization condition, an apparatus ID of the personal-information acquisition apparatus 20 and the like. If a preference including the same information as various information included in the personal information request message RM1 is stored in the preference storage unit 609, the preference acquisition unit 610 acquires the preference.

Further, if any preference including the same information as various information included in the personal information request message RM1 is not stored in the preference storage unit 609, the preference acquisition unit 610 notifies the preference request unit 603 of necessity of transmission of the preference request message RM2.

When having been notified of the necessity of transmission of the preference request message RM2 from the preference acquisition unit 610, the preference request unit 603 transmits the preference request message RM2 to the preference management apparatus 30 just like the preference request unit 103 in the second embodiment described above. When having been not notified of the necessity of transmission of the preference request message RM2, the preference request unit 603 does not transmit any preference request message RM2.

When a preference from the preference storage unit 609 has been acquired by the preference acquisition unit 610, the disclosure permission/non-permission determination unit 605 verifies this preference. For example, the disclosure permission/non-permission determination unit 605 should perform verification by confirming a validity period of the preference having been acquired from the preference storage unit 609, and determining whether the preference is valid, or not. Further, if the preference, which has been acquired from the preference storage unit 609 by the preference acquisition unit 610, is not valid, the disclosure property determination unit 605 notifies the preference request unit 603 of the necessity of transmission of the preference request message RM2.

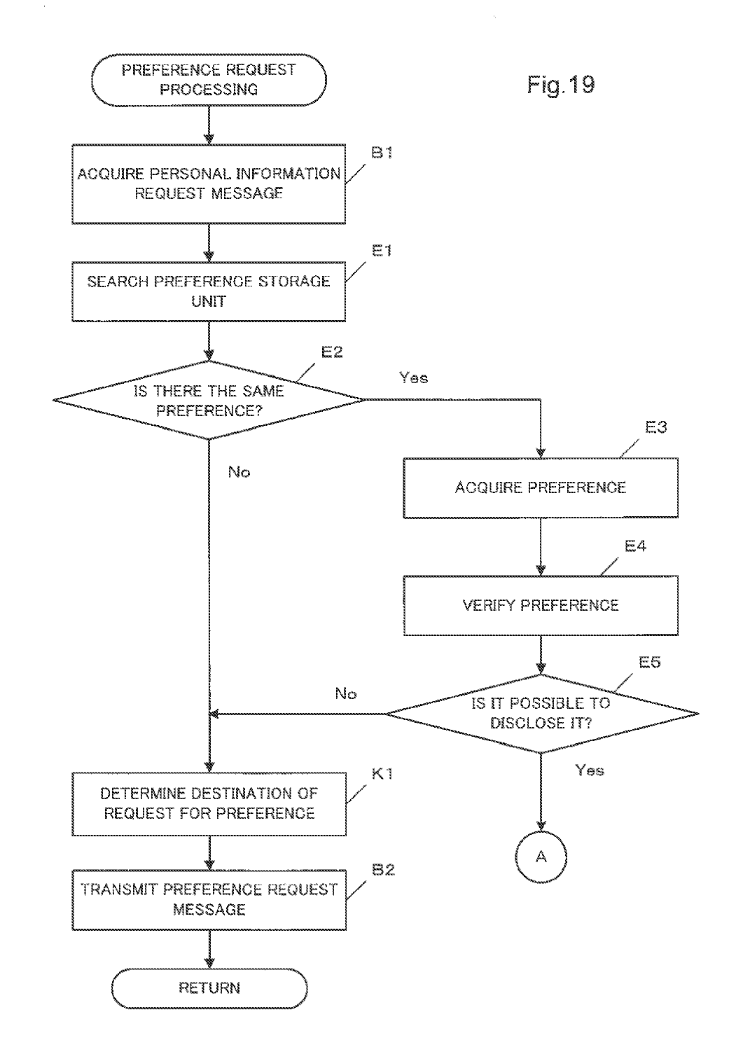

Preference request operation of the personal-information transmission/reception system 3 which is configured in such a way as described above will be described with reference to FIG. 19. The preference request processing shown in FIG. 19 illustrates a processing procedure which is realized by causing the CPU 1001 of the personal-information provision apparatus 60 to execute a corresponding computer program by using the hardware resources shown in FIG. 2. In addition, since the outline of personal information transmission/reception operation, preference confirmation processing and personal information provision processing of the personal-information transmission/reception system 3 are similar to those of the personal-information transmission/reception system 1 according to the first embodiment having been described with reference to FIGS. 10, 12 and 13, description thereof in this embodiment will be omitted.

In FIG. 19, first, the personal-information request reception unit 102 of the personal-information provision apparatus 60 receives the personal information request message RM1 (step B1). Next, the preference acquisition unit 610 searches the preference storage unit 609 for a preference with respect to providing personal information, which is requested by the personal information request message RM1 having been received in step B1, from the personal-information provision apparatus 60 to the personal-information acquisition apparatus 20 (step E1).

For example, the preference acquisition unit 610 searches for a preference including the same pieces of information as a user ID, a kind of personal information, utilization conditions and an apparatus ID of the personal-information acquisition apparatus 20, which are described in the personal information request message RM1 having been acquired in step B1. That is, the preference acquisition unit 610 searches the preference storage unit 609 for a preference representing that a disclosure of personal information based on the contents included in the personal information request message RM1 was already permitted in the past by a relevant user.

If any relevant preference is not searched for (“No” in step E2), the preference request destination determination unit 508 determines a preference management apparatus 30 which becomes a request destination of a preference, based on the preference-management-apparatus information storage unit 507 (step K1). Further, the preference request unit 603 transmits the preference request message RM2 to the preference management apparatus 30 having been determined in step K1 (step B2). In contrast, if a relevant preference has been searched for (“Yes” in step E2), the preference acquisition unit 610 acquires the preference having been searched for (step E3).

Next, the disclosure permission/non-permission determination unit 605 verifies the preference having been acquired in step E3 (step E4), and thereby determines whether or not it is possible to provide the personal information from the personal-information provision apparatus 10 to the personal-information acquisition apparatus 20, based on the preference (step E5). If it has been determined that it is not possible to provide the personal information, the personal-information provision apparatus 60 transmits the preference request message RM2 by performing the processes in step K1 and step B2.

In contrast, it has been determined in step E5 that it is possible to provide the personal information, the preference request processing of the personal-information provision apparatus 60 is terminated, and the process flow proceeds to step D4 and the following steps of the personal information provision processing shown in FIG. 13.

This is the end of description of the preference request processing.

Next, advantageous effects of this third embodiment according to the present invention will be described.

Even when the number of apparatuses possessing personal information has increased, the personal-information transmission/reception system 3 according to the third embodiment can reduce the burden of a user when the user sets preferences, just like in the case of the first and second embodiments. Moreover, according to this embodiment, it is possible to reduce the load on the personal-information provision apparatus 60 which requests preferences to the preference management apparatus 30. A reason of this is that the personal-information provision apparatus 60 stores preferences having been acquired in the past from the preference management apparatus 30 in advance, and does not transmit any preference request message RM2 to the preference management apparatus 30 when having been requested to provide personal information, which can be provided based on the stored preferences, from a personal information acquisition apparatus.

### Fourth Exemplary Embodiment

Next, a fourth exemplary embodiment based on the aforementioned first exemplary embodiment will be described in detail with reference to the drawings. In addition, in each of drawings referred to in description of this embodiment, components which are the same as those of the first embodiment, as well as steps which operate in ways similar to those thereof, are denoted by the same reference signs, and detailed description thereof in this embodiment will be omitted.

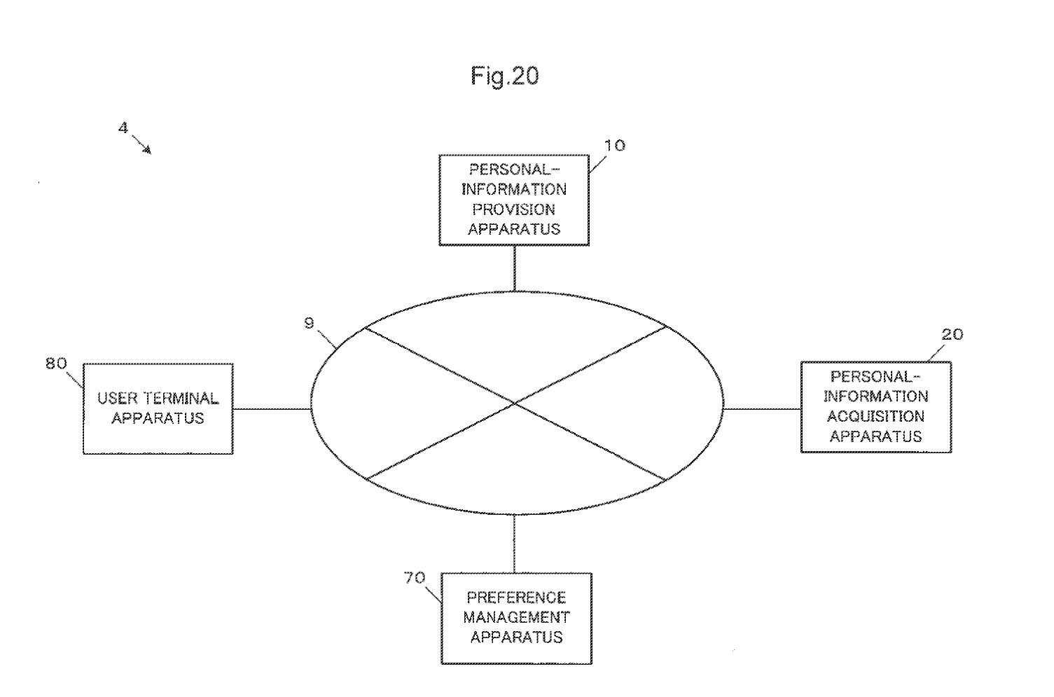

First, a configuration of a personal-information transmission/reception system 4 as this fourth embodiment according to the present invention is illustrated in FIG. 20. In FIG. 20, as compared with the personal-information transmission/reception system 1 as the first embodiment according to the present invention, the personal-information transmission/reception system 4 is different from the above in the configuration in which a preference management apparatus 70 and a user terminal 80 are included therein as substitute for the preference management apparatus 30 and the user terminal 40, respectively.

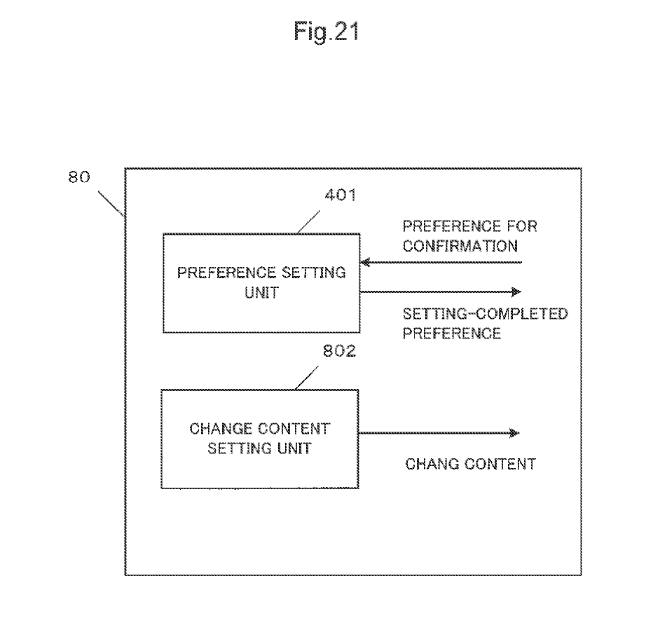

A configuration of function blocks of the user terminal 80 is illustrated in FIG. 21. In FIG. 21, as compared with the user terminal 40 in the first embodiment according to the present invention, the user terminal 80 is different from the above in the configuration in which a preference change content setting unit 802 is further included therein.

It is assumed that the user terminal 80 includes the same hardware resources as those of the user terminal 40 shown in FIG. 5. The preference change content setting unit 802 is realized by the CPU 4001, which reads a corresponding computer program stored in the storage device 4004 or the ROM 4003 into the RAM 4002 and executes it, the network interface 4005, the input apparatus 4006 and the display apparatus 4007. In addition, the configuration of hardware components constituting the preference change content setting unit 802 is not limited to the configuration described above. The preference change content setting unit 802 sets change contents on a setting-completed preference, and transmits a preference, for which settings have been changed, to the preference management apparatus 70.

For example, the preference change content setting unit 802 acquires a list of preferences, each including a user ID having been specified via the input apparatus 4006, from the preference management apparatus 70, and indicates the acquired list of preferences on the display apparatus 4007. Further, the preference change content setting unit 802 acquires the content of a preference, which has been selected from the list, from the preference management apparatus 70 via the input apparatus 4006, and indicates the acquired content on the display device 4007. In this case, the preference change content setting unit 802 acquires a content-change on the indicated preference via the input apparatus 4006, and transmits the acquired change content to the preference management apparatus 70.

For example, it is assumed a case where a preference, in which “a user ID: A, a kind of personal information: a mail address, a handling condition with respect to personal information: to be disclosed to only store sites registered in shopping portals, a personal-information acquisition apparatus: ID0001, and a personal-information provision apparatus: ID0002” are described, was set in the past.

In this case, the preference change content setting unit 802 acquires, for example, a content-change, which causes the content of the handling condition with respect to personal information in the above preference to change into a content such as “to be disclosed to only store sites dealing with music contents among store sites registered in the shopping portal”, via the input unit 4006. Alternatively, the preference change content setting unit 802 may acquire a content-change which causes the content of the handling condition to change into content such as “any disclosure is not permitted”. Further, the preference change content setting unit 802 transmits the acquired content-change to the preference management apparatus 70.

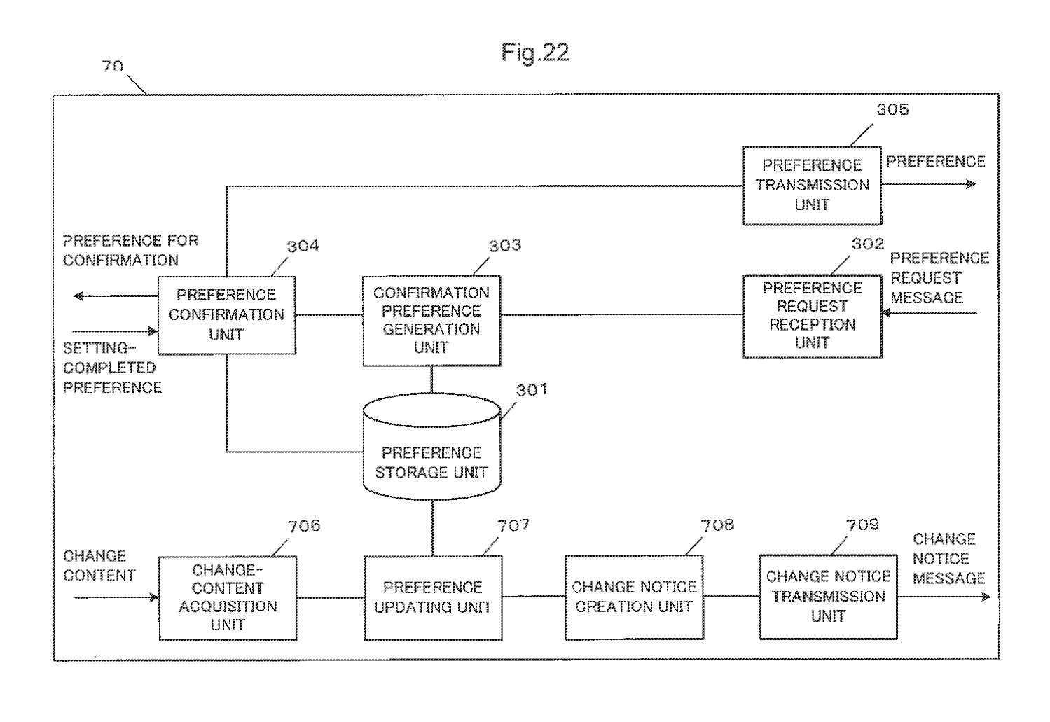

A configuration of function blocks of the preference management apparatus 70 is illustrated in FIG. 22. In FIG. 22, as compared with the preference management apparatus 30 in the first embodiment, the preference management apparatus 70 is different from the above in the configuration in which a content-change acquisition unit 706, a preference updating unit 707, a change notice generation unit 708 and a change notice transmission unit 709 are further included therein.

It is assumed that the preference management apparatus 70 includes the same hardware resources as those of the preference management apparatus 30 shown in FIG. 4. The content-change acquisition unit 706 and the change notice transmission unit 709 are realized by the CPU 3001, which reads corresponding computer programs stored in the storage device 3004 or the ROM 3003 into the RAM 3002 and executes them, and the network interface 3005. The reference updating unit 707 and the change notice generation unit 708 are realized by the CPU 3001 which reads corresponding computer programs stored in the storage device 3004 or the ROM 3003 into the RAM 3002 and executes them. It is noted that the configuration of hardware components constituting the individual function blocks of the preference management apparatus 70 is not limited to the configuration described above.

The content-change acquisition unit 706 acquires a content-change on a preference, which has been set in the past, from the user terminal 80. For example, as described above, the content-change may be a change on a handling condition with respect to a preference, a change of a valid period, or the like.

The preference updating unit 707 updates a preference stored in the preference storage unit 301 based on the content-change having been acquired by the content-change acquisition unit 706.

The preference change notice generation unit 708 identifies a personal-information provision apparatus 10 and a personal-information acquisition apparatus 20 in relation to a preference having been updated by the preference updating unit 707, and generates a preference change notice for the identified personal-information provision apparatus 10 and personal-information acquisition apparatus 20. For example, the preference change notice generation unit 708 identifies a personal-information provision apparatus 10 which transmitted a pre-updating preference in the past, and a personal-information acquisition apparatus 20 corresponding to a disclosure destination described in the pre-updating preference, as destinations of the change notice. In addition, the preference change notice generation unit 708 may generate a change notice only when the updating makes a handling condition stricter, but may not generate any change notice when the updating makes the handling condition looser.

The preference change notice transmission unit 709 transmits the preference change notice to each of the personal-information provision apparatus 10 and the personal-information acquisition apparatus 20 having been identified by the preference change notice generation unit 708.

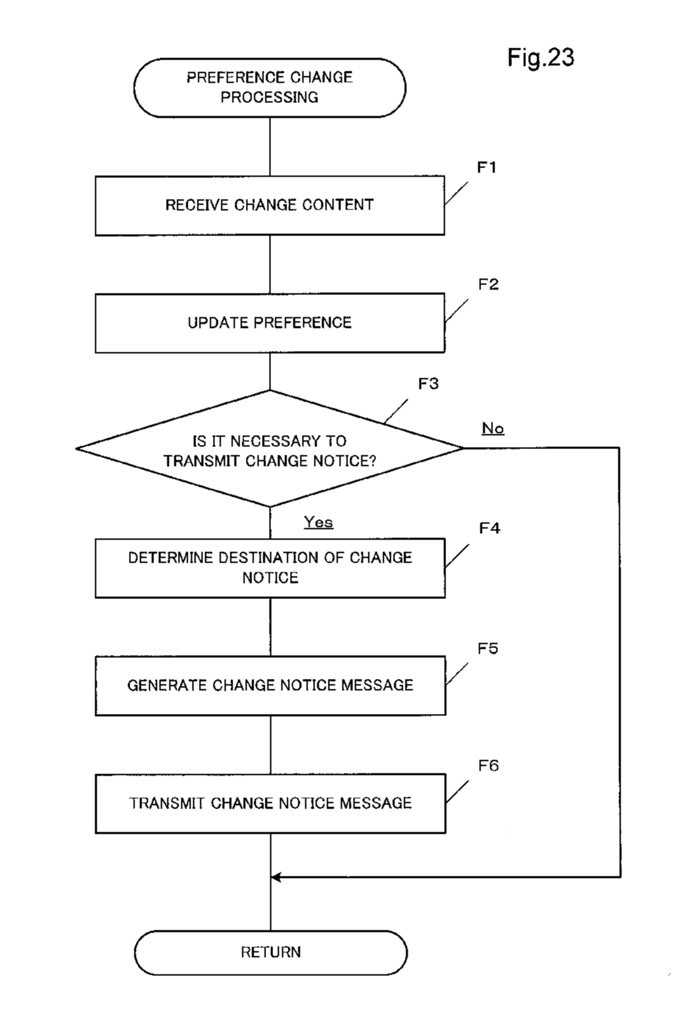

Preference update operation of the personal-information transmission/reception system 4 which is configured in such a way as described above will be described with reference to FIG. 23. In addition, since the outline of personal information transmission/reception operation, preference request processing, preference confirmation processing and personal information provision processing of the personal-information transmission/reception system 4 are similar to those of the personal-information transmission/reception system 1 according to the first embodiment having been described with reference to FIGS. 10 to 13, description thereof in this embodiment will be omitted.

In FIG. 23, first, the content-change acquisition unit 706 of the preference management apparatus 70 acquires a content-change on a preference, from the preference change content setting unit 802 of the user terminal 80 (step F1). Next, the preference updating unit 707 updates a preference stored in the preference storage unit 301 based on the content-change (step F2).

Next, the preference change notice generation unit 708 determines whether or not it is necessary to notify the change of the preference to other apparatuses, based on the content-change having been acquired in step F1 (step F3). For example, if a handling condition with respect to personal information, included in the content-change having been acquired in step F1, is stricter than a handling condition included in a pre-updating preference, the preference change notice generation unit 708 determines that it is necessary to notify the change of the preference to other apparatuses.

In step F3, if it has been determined that it is unnecessary to notify the change of the preference, the personal-information transmission/reception system 4 terminates this preference update processing. In contrast, if it has been determined in step F3 that it is necessary to notify the change of the preference, the preference change notice generation unit 708 determines apparatuses to which the preference change notice is to be transmitted (step F4).

For example, the preference change notice generation unit 708 determines a personal-information provision apparatus 10 which transmitted the pre-updating preference in the past, a personal-information acquisition apparatus 20 which was prescribed as a provision destination of personal information in the pre-updating preference, and the like, as apparatuses to which the preference change notice is to be transmitted.

Next, the preference change notice generation unit 708 generates a preference change notice message (step F5). For example, the preference change notice message may include the content-change having been acquired in step F1 and the pre-updating preference.

Next, the change notice transmission unit 709 transmits the preference change notice message to each of the apparatuses having been determined in step F4 (step F6).

With the above processing, the personal-information transmission/reception system 4 terminates this preference update processing.

Next, advantageous effects of the fourth embodiment according to the present invention will be described.

Even when the number of apparatuses possessing personal information has increased, the personal-information transmission/reception system 4 according to the fourth embodiment can reduce the burden of a user when the user updates preferences with respect to disclosures of personal information. A reason of this is that, when having acquired a content-change on a preference, the preference management apparatus 70 updates a preference stored in the preference storage unit 301, and further transmits a change notice to other apparatuses (a personal-information provision apparatus 10 and a personal-information acquisition apparatus 20) in relation to the relevant preference. For this reason, according to this embodiment, a user does not need to, for each of apparatuses possessing personal information, update a corresponding preference. Moreover, according to this embodiment, even when a preference has been updated, the personal-information provision apparatus 10 and the personal-information acquisition apparatus 20 can transmit and receive relevant personal information based on the preference having consistency.

### Fifth Exemplary Embodiment

Next, a fifth exemplary embodiment based on the aforementioned first exemplary embodiment will be described in detail with reference to the drawings. In addition, in each of drawings referred to in description of this embodiment, components which are the same as those of the first embodiment, as well as steps which operate in ways similar to those thereof, are denoted by the same reference signs, and detailed description thereof in this embodiment will be omitted.

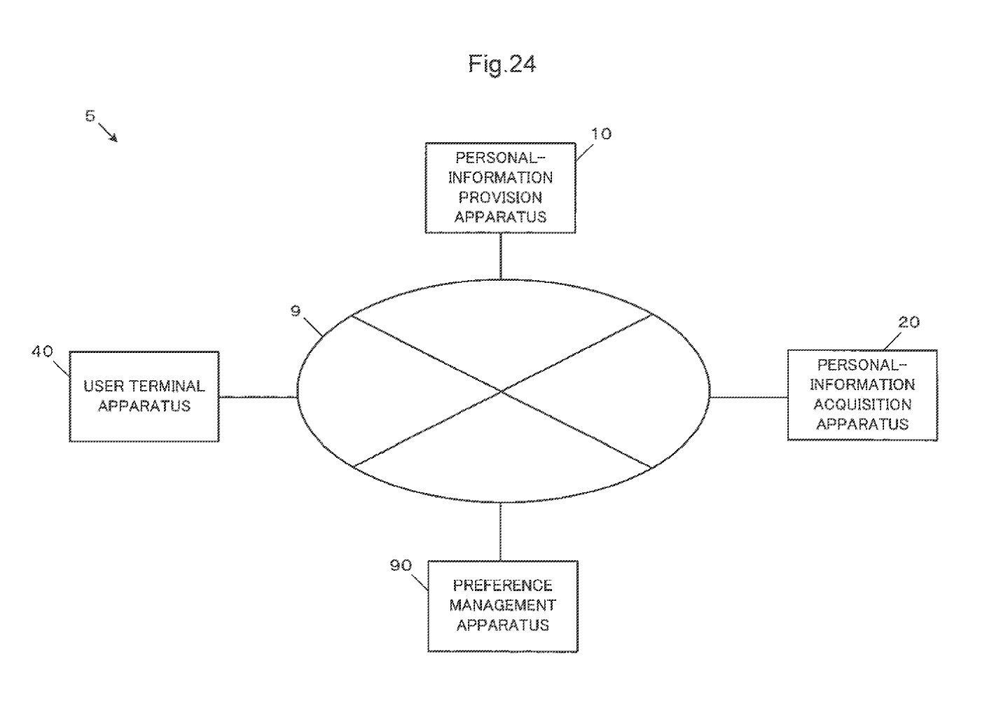

First, a configuration of a personal-information transmission/reception system 5 according to this fifth embodiment is illustrated in FIG. 24. In FIG. 24, as compared with the personal-information transmission/reception system 1 in the first embodiment, the personal-information transmission/reception system 5 is different from the above in the configuration in which a preference management apparatus 90 is included therein as substitute for the preference management apparatus 30.

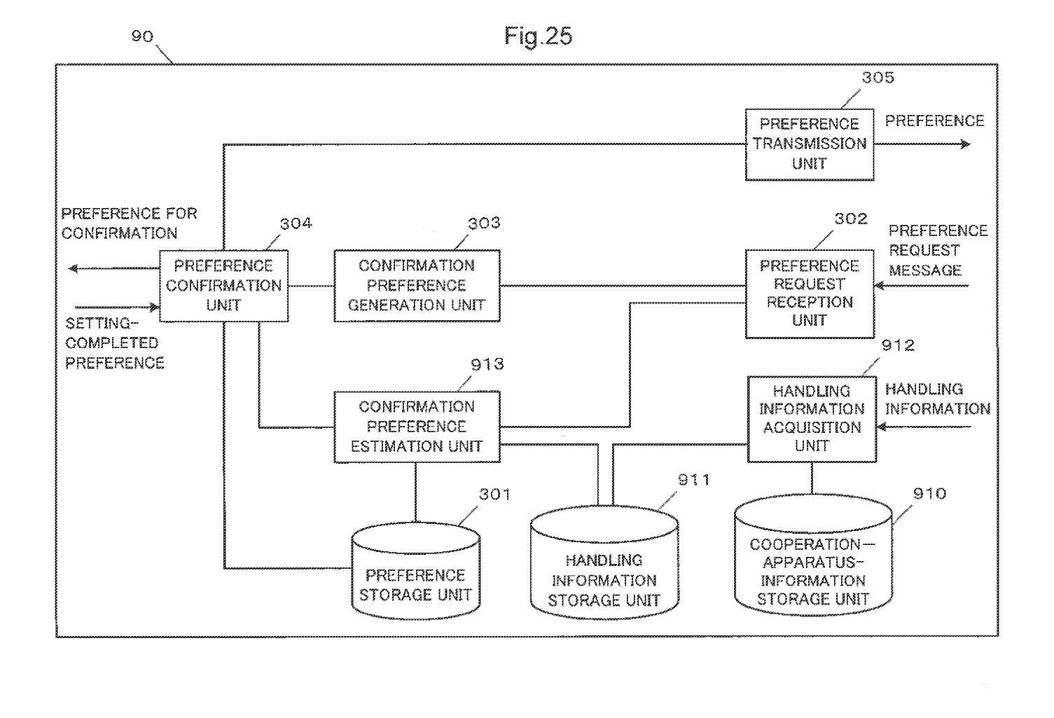

A configuration of function blocks of the preference management apparatus 90 is illustrated in FIG. 25. In FIG. 25, as compared with the preference management apparatus 30 in the first embodiment, the preference management apparatus 90 is different from the above in the configuration in which a cooperation-apparatus-information storage unit 910, a handling information storage unit 911, a handling information acquisition unit 912 and a confirmation preference estimation unit 913 are further included therein.

Here, it is assumed that the preference management apparatus 90 includes the same hardware resources as those of the preference management apparatus 30 shown in FIG. 4. The cooperation-apparatus-information storage unit 910 and the handling information storage unit 911 are realized by the storage device 3004. The handling information acquisition unit 912 and the confirmation preference estimation unit 913 are realized by the CPU 3001, which reads corresponding computer programs into the RAM 3002 and executes them, and the network interface 3005. It is noted that hardware components constituting each of the function blocks of the preference management apparatus 90 are not limited to the components described above.

The cooperation-apparatus-information storage unit 910 stores pieces of information each being related to a cooperation apparatus with which the cooperation-apparatus-information storage unit 910 cooperates. The cooperation apparatus may be, for example, a personal-information provision apparatus 10 which has been registered in advance as a provision destination of a preference from the preference management apparatus 90. The cooperation apparatus may be, for example, a personal-information acquisition apparatus 20 which is permitted, as a disclosure destination of personal information, by a preference managed by the preference management apparatus 90. Further, the piece of information related to the cooperation apparatus may includes, for example, an apparatus ID of any apparatus of these personal-information provision apparatus 10 and personal-information acquisition apparatus 20, a URL of the apparatus, and the like.

The cooperation-apparatus-information storage unit 910 may store the piece of information each being related to the cooperation apparatus by being registered in advance. Alternatively, the cooperation-apparatus-information storage unit 910 may store piece of information related to respective the personal-information provision apparatus 10 and the personal-information acquisition apparatus 20 included in the preference request message RM2 as the pieces of information each being related to a cooperation apparatus. Alternatively, in response to reception of a preference from the user terminal 40, the cooperation-apparatus-information storage unit 910 may store pieces of information related to the respective personal-information provision apparatus 10 and the personal-information acquisition apparatus 20 described in the received preference as the pieces of information each being related to a cooperation apparatus.

The handling information storage unit 911 stores, for each of the cooperation apparatuses described above, handling information with respect to handling of personal information, which is disclosed by the cooperation apparatus. Here, the handling information may be, for example, a privacy policy, a service-provision condition or the like.

The handling information acquisition unit 912 accesses one or more cooperation apparatuses registered in the cooperation-apparatus-information storage unit 910, and acquires handling information related to each of the cooperation apparatuses. Further, the handling information acquisition unit 912 stores the acquired handling information related to each of the cooperation apparatuses into the handling information storage unit 911.

The confirmation preference estimation unit 913 extracts similar preferences each including a personal-information acquisition apparatus 20 and a personal-information provision apparatus 10 which are similar to the information related to the personal-information acquisition apparatus 20 and the personal-information provision apparatus 10 included in the preference request message RM2, respectively, based on the handling information storage unit 911. Further, the confirmation preference estimation unit 913 estimates a confirmation preference CP based on the extracted similar preferences.

Specifically, the confirmation preference estimation unit 913 classifies personal-information provision apparatuses 10 and personal-information acquisition apparatuses 20 included in the preferences stored in the preference storage unit 301 into a corresponding plurality of groups, based on the handling information storage unit 911.

Further, the confirmation preference estimation unit 913 determines a group to which the personal-information provision apparatus 10 and the personal-information acquisition apparatuses 20 included in the preference request messages RM2 belongs, and a group to which a personal-information acquisition apparatus 20 included in the preference request messages RM2 belongs, based on the handling information storage unit 911. Moreover, the confirmation preference estimation unit 913 extracts preferences, as similar preferences, each of which was set in the past when personal information was provided from any one of the personal-information provision apparatuses 10 belonging to the group, which is the same group as that of the personal-information provision apparatuses 10 included in the preference request messages RM2, to any one of the personal-information acquisition apparatuses 20 belonging to the group, which is the same group as that of the personal-information acquisition apparatuses 20 included in the preference request messages RM2.

Further, the confirmation preference estimation unit 913 calculates, based on preferences stored in the preference storage unit 301, kind-based evaluation values regarding pieces of personal information included in the respective preferences. Here, the kind-based evaluation value regarding personal information may be, for example, a privacy degree, or the like, representing a degree of permission made by a user with respect to disclosures of personal information of a certain kind.

Moreover, the confirmation preference estimation unit 913 calculates a kind-based evaluation value regarding personal information which is requested by the preference request messages RM2.

Further, the confirmation preference estimation unit 913 further extracts preferences, as similar preferences, each of which includes personal information of a certain kind with which a kind-based evaluation, which falls within a predetermined range based on the kind-based evaluation value regarding personal information which is requested, is associated.

For example, the confirmation preference estimation unit 913 may calculate, based on disclosure states, such as the number of personal-information acquisition apparatuses 20 to which pieces of personal information of a certain kind have been disclosed from one personal-information provision apparatus 10, an evaluation value regarding the certain kind. The confirmation preference estimation unit 913 may obtain information related to such disclosure states by aggregating kinds of personal information, apparatus IDs of the personal-information provision apparatuses 10 and apparatus IDs of the personal-information acquisition apparatuses 20, which are included in the preferences stored in the preference storage unit 301.

In addition, the confirmation preference estimation unit 913 may calculate a kind-based evaluation value regarding personal information based on information included in the preference request message RM2. In this case, the preference request unit 103 of the personal-information provision apparatus 10 is configured such that a disclosure state for each kind of personal information in the apparatus itself is transmitted so as to be included in the preference request message RM2.

Further, the confirmation preference estimation unit 913 may extract similar preferences based on the classifications of the personal-information provision apparatuses 10s and the personal-information acquisition apparatuses 20s, and evaluation values regarding respective kinds of personal information. Further, the confirmation preference estimation unit 913 generates a confirmation preference CP to be presented to a user by estimating the confirmation preference CP based on the similar preferences.

For example, it is assumed a case where a preference for use in providing a credit-card number from a personal-information provision apparatus 10 having an apparatus ID0001 to a personal-information acquisition apparatus 20 having an apparatus ID0002 is requested by the preference request message RM2. At this time, the confirmation preference estimation unit 913 extracts preferences, as similar preferences, in each of which personal information of a kind having an evaluation value larger than or equal to “five”, which is an evaluation value of the credit-card number, is permitted to be disclosed from any one of the personal-information provision apparatuses 10s included in a group A, which is the same group as that of the personal-information provision apparatus 10 having the apparatus ID0001, to any one of the personal-information acquisition apparatuses 20s included in a group B which is the same group as that of the personal-information acquisition apparatus 20 having the apparatus ID0002.

In this case, the confirmation preference estimation unit 913 aggregates handling conditions with respect to the similar preferences. At this time, it is assumed that the number of a handling condition such as “any provision to a third party is not permitted” is more than any other handling condition. In this case, the confirmation preference estimation unit 913 estimates a confirmation preference CP having a content such as “when providing a credit-card number from the personal-information provision apparatus 10 having the apparatus ID0001 to the personal-information acquisition apparatus 20 having the apparatus ID0002, its disclosure is agreed on the condition that ‘any provision to a third party is not permitted’ is observed as a handling condition”.

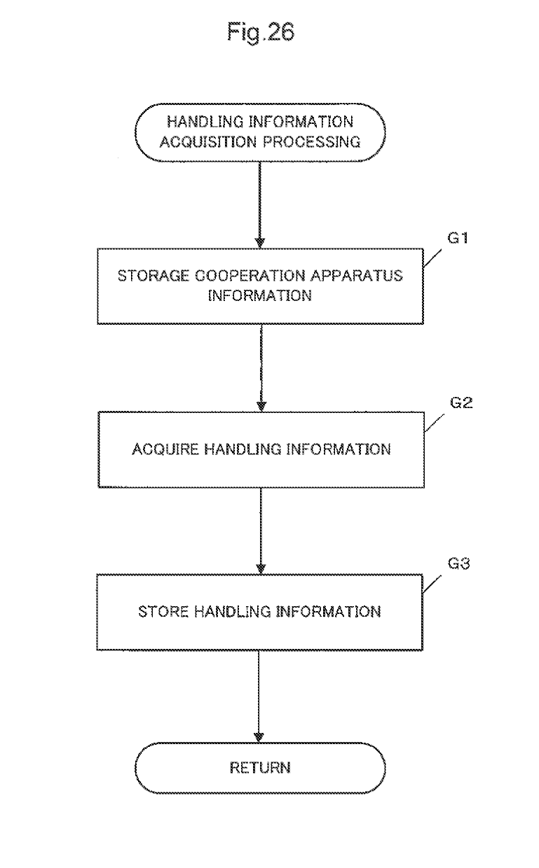

Handling information acquisition processing, preference confirmation processing and preference estimation processing of the personal-information transmission/reception system 5, which is configured in such a way as described above, will be described with reference to FIGS. 26 to 28. Since the outline of personal information transmission/reception operation, preference request processing and personal information provision processing of the personal-information transmission/reception system 5 are similar to those of the personal-information transmission/reception system 1 according to the first embodiment having been described with reference to FIGS. 10, 11 and 13, description thereof in this embodiment will be omitted.

First, the handling information acquisition processing of the personal-information transmission/reception system 5 will be described with reference to FIG. 26. It is noted that the preference management apparatus 90 executes this handling information acquisition processing in advance before execution of the preference confirmation processing which will be described below.

First, the cooperation-apparatus-information storage unit 910 stores cooperation apparatus information (step G1). For example, the cooperation-apparatus-information storage unit 910 may store cooperation apparatus information having been registered by an administrator of the preference management apparatus 90. Further, the cooperation apparatus information may include apparatus IDs for identifying respective cooperation apparatuses, and URLs of the respective apparatuses.

Next, the handling information acquisition unit 912 acquires handling information with respect to individual cooperation apparatuses registered in the cooperation-apparatus-information storage unit 910 (step G2). For example, the handling information to be acquired may include privacy policies, service-provision conditions and the like which are disclosed by individual apparatuses. In addition, as such handling information, the handling information acquisition unit 912 may acquire, for example, information published at websites by individual apparatuses.

Next, the handling information storage unit 911 stores the information having been acquired by the handling information acquisition unit 912 (step G3).

With the above processing, the preference management apparatus 90 terminates the handling information acquisition processing.

Next, the details of the preference confirmation processing of the personal-information transmission/reception system 5 will be described.

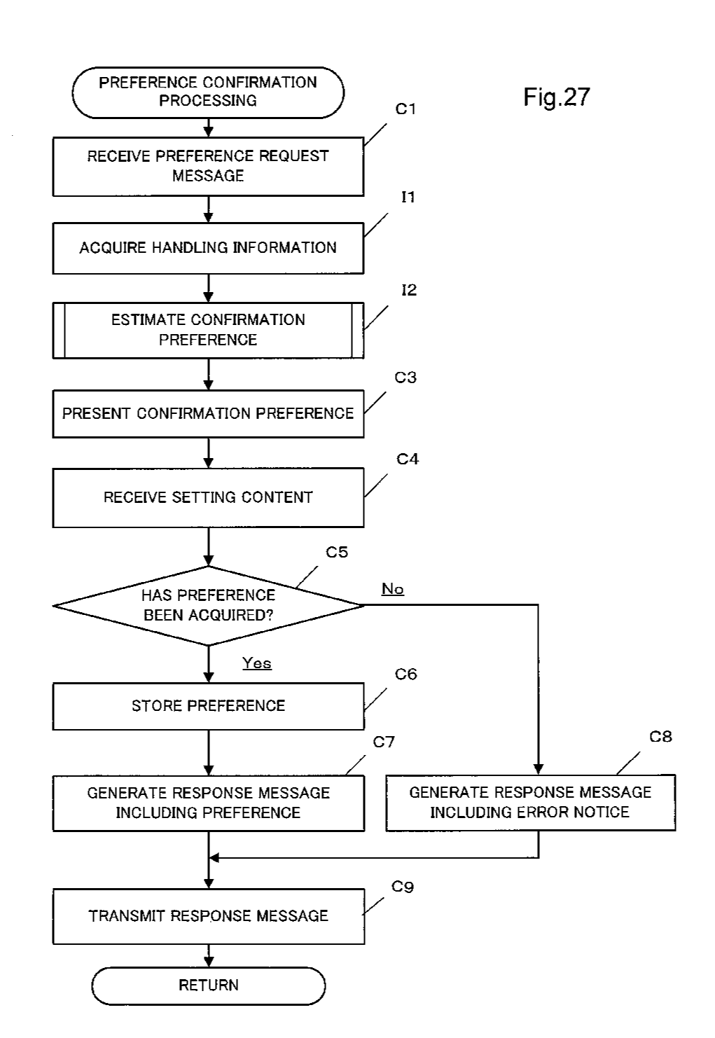

In FIG. 27, as compared with the preference confirmation processing of the preference management apparatus 30 in the first embodiment, having been described by using FIG. 12, the preference confirmation processing of the preference management apparatus 90 is different from the above in the configuration in which processing in step I1 and step I2 is performed instead of the processing in step C2.

After processing in step C1 has been performed, the confirmation preference estimation unit 913 acquires handling information, which is related to the personal-information provision apparatus 10 and the personal-information acquisition apparatus 20 included in the preference request message RM2 having been received in step C1, from the handling information storage unit 911 (step I1).

Next, the confirmation preference estimation unit 913 extracts preferences, as similar preference, each being similar to a preference requested by the preference request message RM2 having been received in step C1, from among the preferences having been stored into the preference storage unit 301 based on the handling information having been acquired in step I1. Further, the confirmation preference estimation unit 913 estimates the confirmation preference CP based on the extracted similar preferences (step I2).

Subsequently, the preference management apparatus 90 performs the processing in steps C3 to C9 just like in the case of the preference management apparatus 30 in the first embodiment, and thereby transmits a preference having been acquired from the user terminal 40 to the personal-information provision apparatus 10.

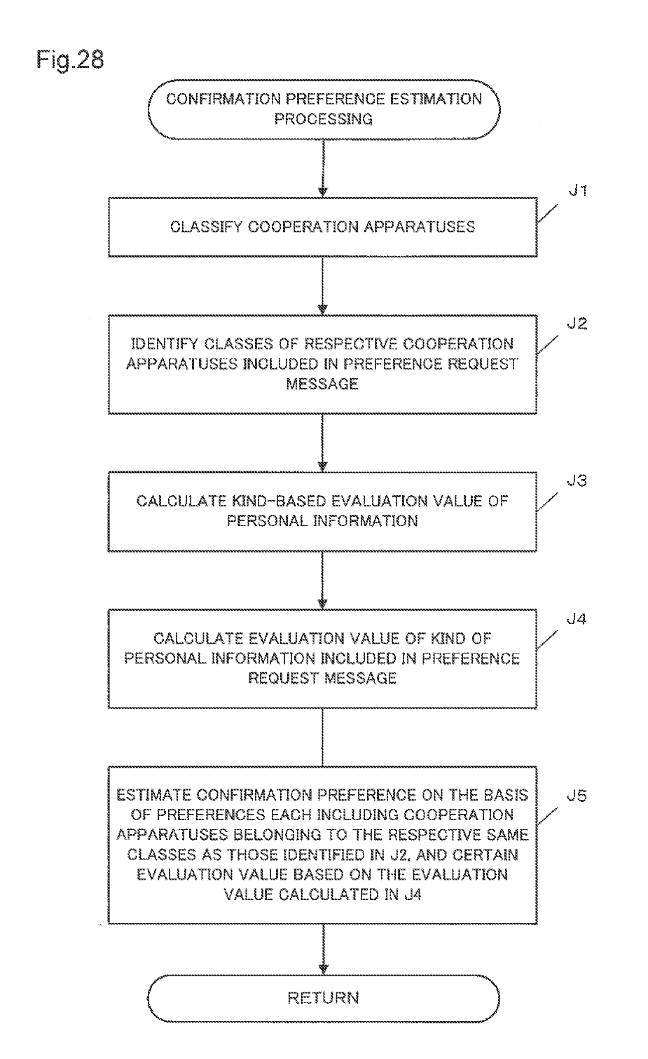

Here, the details of the confirmation preference estimation processing in step I2 will be described with reference to FIG. 28. First, the confirmation preference estimation unit 913 classifies cooperation apparatuses based on the handling information related to the individual cooperation apparatuses, stored in the handling information storage unit 911 (step J1). For example, the confirmation preference estimation unit 913 may calculate similarity degrees or distances with respective to items and their contents, which are included in the handling information related to the individual cooperation apparatuses, and may perform the classification of the cooperation apparatuses based on the magnitudes of the calculated similarity degrees or distances. Further, as a technology for the classification based on the similarity degrees or the distances, an existing technology employing pattern recognition, a Bayes inference, a neural network method or the like should be used.

Next, the confirmation preference estimation unit 913 acquires classes to which the personal-information provision apparatus 10 corresponding to an apparatus ID and the personal-information acquisition apparatus 20 corresponding to an apparatus ID, the apparatus IDs being included in the preference request message RM2, belong, respectively, based on the classification having been performed in step J1 (step J2).

Next, the confirmation preference estimation unit 913 calculates kind-based evaluation values regarding personal information included in the preferences stored in the preference storage unit 301 (step J3). Next, the confirmation preference estimation unit 913 calculates an evaluation value regarding a kind of personal information included in the preference request message RM2 (step J4).

For example, in steps J2 and J3, as described above, the confirmation preference estimation unit 913 may calculate privacy degrees, each being calculated based on a disclosure state of a corresponding kind of personal information, as the kind-based evaluation values regarding personal information.

Next, the confirmation preference estimation unit 913 extracts similar preferences from the preference storage unit 301 based on the classes to which the personal-information provision apparatus 10 and the personal-information acquisition apparatus 20 included in the preference request message RM2 belong, respectively, as well as the evaluation value of a kind of personal information included in the preference request message RM2, the classes and the evaluation value having been acquired in steps J2 and J4, respectively. Further, the confirmation preference estimation unit 913 estimates the confirmation preference CP to be presented to the user terminal 40 based on the similar preferences (step J5).

For example, as the similar preferences, the confirmation preference estimation unit 913 extracts preferences satisfying the following items, from the preference storage unit 301;
the personal-information provision apparatus 10 included in the same class as the class A, regarding classes A and B to which the personal-information provision apparatus 10 and the personal-information acquisition apparatus 20 included in the preference request message RM2 belong, respectively;
the personal-information acquisition apparatuses 20 included in the same class as the class B; and
personal information of a certain kind whose evaluation value is larger than or equal to “five” which is an evaluation value of the kind of a “credit-card number” included in the preference request message RM2.

Moreover, in this case, the confirmation preference estimation unit 913 generates the confirmation preference CP to which a handling condition stating “any provision to a third party is not permitted” is applied, the handling condition being one whose number is larger than that of any other similar preference having been extracted.

With the above processing, the preference management apparatus 90 terminates the confirmation preference estimation processing.

It is noted that, in the confirmation preference estimation processing, the classifying processing by the cooperation apparatuses in step J1 and the processing for calculating kind-based evaluation values regarding personal information in step J3 may be performed in advance.

Next, advantageous effects of the fifth embodiment according to the present invention will be described.

According to the personal-information transmission/reception system according to the fifth embodiment, even when there do not exist any preferences which were set in the past by a relevant user, furthermore, it is possible to reduce the burden of the user who sets preferences. A reason of this is that the confirmation preference estimation unit 303 extracts similar preferences similar to a preference which is requested, based on pieces of personal-information handling information related to the personal-information provision apparatuses 10s and the personal-information acquisition apparatuses 20s, and estimates the confirmation preference CP to be presented to a relevant user terminal based on the extracted similar preferences.

Moreover, a further reason why it is possible to enjoy the above-described advantageous effect of this embodiment is that, through calculations of kind-based evaluation values regarding personal information, the confirmation preference estimation unit 913 extracts similar preferences each targeting personal information of a certain kind, with which an evaluation value falling within a predetermined range based on an evaluation value of a kind of personal information targeted by a requested preference is associated, and estimates a confirmation preference CP to be presented to a relevant user terminal based on the extracted preferences.

### Sixth Exemplary Embodiment

Next, a sixth exemplary embodiment based on the first exemplary embodiment described above will be described. This embodiment is an example in which the personal-information transmission/reception system 1 as the first embodiment according to the present invention is applied to a shopping portal system for mobile telephone terminals.

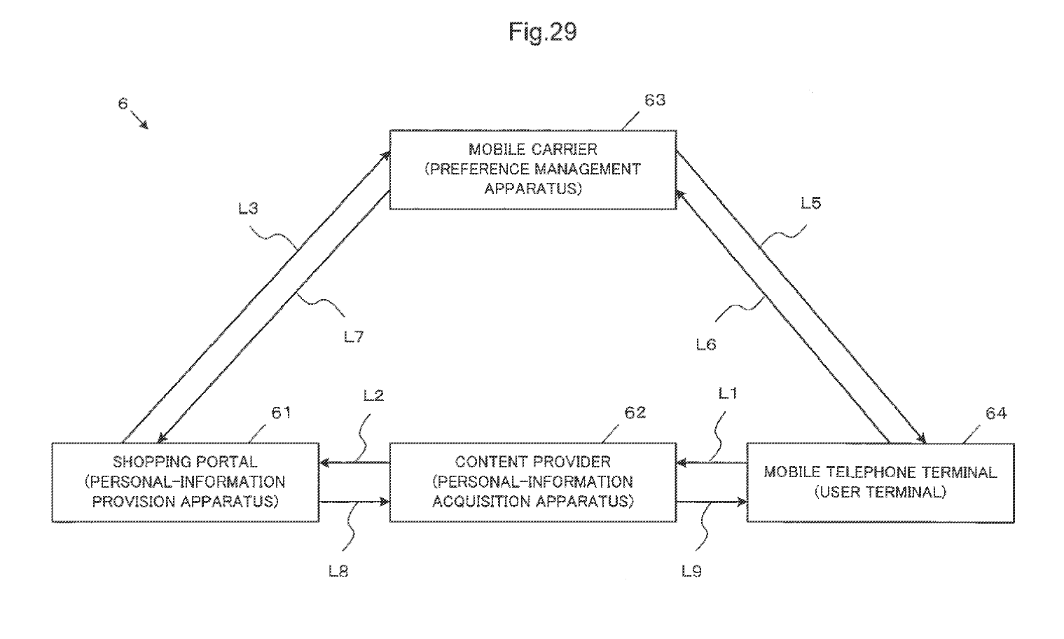

A configuration of a mobile-telephone-terminal shopping portal system 6 as the sixth embodiment according to the present invention is illustrated in FIG. 29. In FIG. 29, the mobile-telephone-terminal shopping portal system 6 includes a shopping portal 61 corresponding to the personal-information provision apparatus 10, a content provider 62 corresponding to the personal-information acquisition apparatus 20, a mobile carrier 63 as the preference management apparatus 30 and a mobile telephone terminal 64 as the user terminal 40. Further, these apparatuses are connected so as to be communicable with one another via the network 9.

For the convenience of description, the mobile-telephone-terminal shopping portal system 6 shown in FIG. 29 is configured so as to include one apparatus for each of the shopping portal 61, the content provider 62, the mobile carrier 63 and the mobile telephone terminal 64. It is noted that the present invention is not limited to this configuration, but may be a system which is configured such that any of these kinds of apparatuses above appropriately includes a plurality of apparatuses.

The shopping portal 61 possesses personal information, and provides personal information of the possessed personal information in accordance with a request from the content provider 62. Further, the shopping portal 61 requests a preference, which is needed when transmitting personal information to the content provider 62, to the mobile carrier 63. Here, in the preference request message RM2 of this embodiment, an apparatus ID of the content provider 62, which becomes a provision destination of personal information, a kind of personal information to be provided, and the like, are described.

The content provider 62 acquires a content request from the mobile telephone terminal 64, and provides the content to the mobile telephone terminal 64. At this time, in order to determine whether or not it is permitted to provide the content to the mobile telephone terminal 64, the content provider 62 needs personal information regarding a user of the mobile telephone terminal 64. For this reason, the content provider 62 requests the personal information regarding the relevant user to the shopping portal 61.

The mobile carrier 63 acquires a message for requesting a preference, from the shopping portal 61, and provides a preference having been acquired from the mobile telephone terminal 64 thereto. At this time, in order to acquire the preference from the mobile terminal 94, the mobile carrier 63 transmits the confirmation preference CP to the mobile telephone 94, and acquires a setting content on this confirmation preference CP from the mobile telephone 94.

The mobile telephone terminal 64 accesses the content provider 62 to request a content. Further, the mobile telephone terminal 64 transmits the setting content on the confirmation preference CP, which is transmitted from the mobile carrier 63, to the mobile carrier 63.

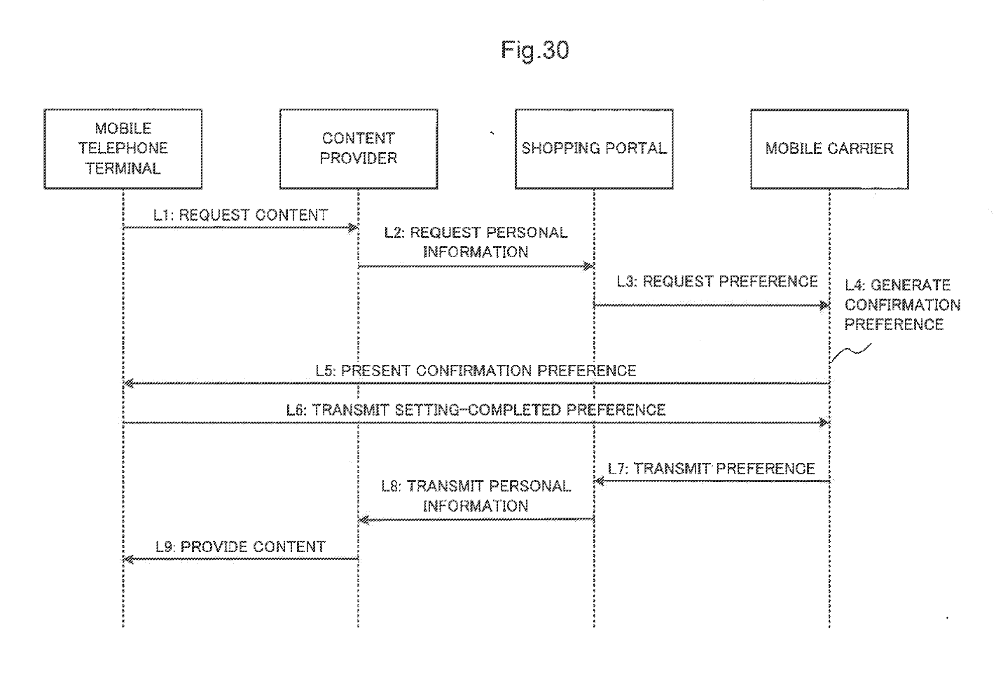

Operation of the mobile-telephone-terminal shopping portal system 6, which is configured in such a way as described above, will be described with reference to FIGS. 29 and 30.

First, the mobile telephone terminal 64 requests the content to the content provider 62 (step L1). Next, the content provider 62 requests personal information, which is needed to confirm whether or not it is permitted to provide this content to the mobile telephone terminal 64, to the shopping portal 61 (step L2).

Next, the shopping portal 61, which has received the personal information request message RM1, requests a preference, which is needed to determine whether or not it is permitted to provide this personal information to the content provider 62, to the mobile carrier 63 (step L3).

Next, the mobile carrier 63, which has received the preference request message RM2, generates the confirmation preference CP to prescribe whether or not it is permitted to provide this personal information from the shopping portal 61 to the content provider 62 (step L4).

At this time, the mobile carrier 63 generates the confirmation preference CP based on preferences having been set in the past by the relevant user and similar preferences similar to the requested preference.

Next, the mobile carrier 63 presents the confirmation preference CP having been generated in step L4 as well as the content of the preference request having been acquired in step L3 to the mobile telephone terminal 64 (step L5).

In such a way as described above, the mobile carrier 63 is able to reduce the burden of a user who sets preferences, by presenting the confirmation preference CP, which has been generated based on preferences having been set in the past as well as similar preferences, to the mobile telephone terminal 64.

Next, the mobile telephone terminal 64 transmits information, which represents the content of settings performed by the user on the confirmation preference CP, to the mobile carrier 63 (step L6).

The processing in steps L5 and L6 is performed by direct communication between the mobile carrier 63 and the mobile telephone terminal 64. As a technology for the direct communication, for example, a redirection function of a web browser application installed in the mobile telephone terminal 64, transmitting and receiving of e-mails or the like is applicable.

Next, the mobile carrier 63 provides the shopping portal 61 with a preference having been set by applying the acquired setting result to the confirmation preference CP (step L7).

Next, the shopping portal 61 determines whether or not it is possible to provide the personal information to the content provider 62, based on the acquired preference. Further, if it is determined that the provision is possible, the shopping portal 61 provides the personal information to the content provider 62 (step L8).

Next, the content provider 62, which has acquired the personal information, determines whether or not it is possible to provide a content to the mobile telephone terminal 64, based on the acquired personal information. Further, if it is determined that the provision is possible, the content provider 62 provides the content to the mobile telephone terminal 64 (step L9).

With the above processing, the mobile-telephone-terminal shopping portal system 6 terminates the operation.

Next, advantageous effects of the sixth embodiment according to the present invention will be described.

Even when the number of the shopping portals possessing personal information and the number of the content providers have increased, the mobile-telephone-terminal shopping portal system 6 according to the sixth embodiment can reduce the burden of a user who sets preferences each prescribing conditions with respect to disclosures of personal information, and the proprieties of the disclosures thereof. A reason of this is that the mobile carrier 63 acquires a preference with respect to disclosures of personal information from the shopping portal 61 to the content provider 62, from the mobile terminal 64, and the shopping portal 61 provides the personal information to the content provider 62 based on the preference having been acquired by the mobile carrier 63.

That is, in the mobile-telephone-terminal shopping portal system 6 according to the sixth embodiment, since the mobile carrier 63 performs centralized management of preferences, the user of the mobile telephone terminal 64 does not need to set a preference with respect to disclosures of personal information for each of the shopping portals possessing personal information and the content providers.

### Seventh Exemplary Embodiment

Next, a seventh exemplary embodiment based on the first exemplary embodiment described above will be described. In this embodiment, an example, in which the personal-information transmission/reception system 1 according to the first embodiment is applied to an application service provider (ASP) foundation system, will be described.

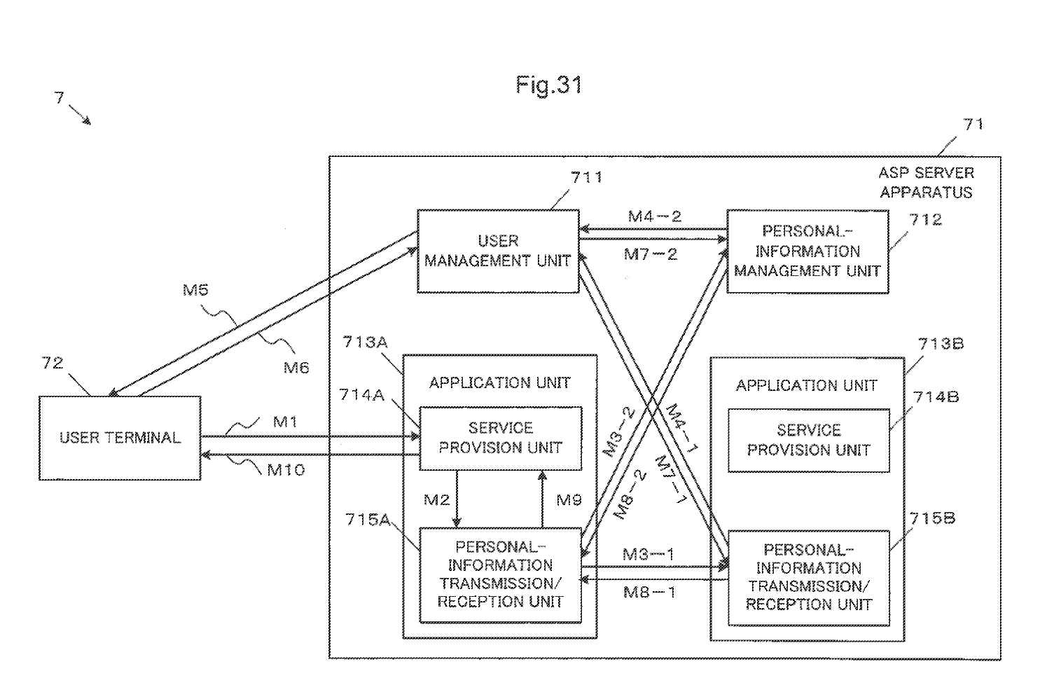

A configuration of an ASP foundation system 7 as the seventh embodiment according to the present invention is illustrated in FIG. 31. In FIG. 31, the ASP foundation system 7 includes an ASP server apparatus 71 and a user terminal 72. The ASP server apparatus 71 and the user terminal 72 are connected so as to be communicable with each other via the network 9. Each of the ASP server apparatus 71 and the user terminal 72 can be realized by a computer. That is, it is possible to employ the computer (the information processing apparatus) shown in each of FIGS. 2 to 4 as hardware resources of the ASP server apparatus 71. It is possible to employ the computer (the information processing apparatus) shown in FIG. 5 as hardware resources of the user terminal 72.

The ASP server apparatus 71 includes a user management unit 711, a personal-information management unit 712, and application units 713A and 713B (hereinafter, collectively also referred to as an application unit 713).

The user management unit 711 is realized by a CPU (1001 or the like) for reading a corresponding computer program, which is stored in a storage apparatus (1004 or the like) of the computer constituting the ASP server apparatus 71, and which causes the ASP server apparatus 71 to operate as the preference management apparatus 30, into a RAM (1002 or the like) and executing the computer program, the storage apparatus (1004 or the like) and a network interface (1005 or the like).

Further, the personal-information management unit 712 is realized by a CPU (1001 or the like) for reading a corresponding computer program, which is stored in a storage apparatus (1004 or the like) of the computer constituting the ASP server apparatus 71, and which causes the ASP server apparatus 71 to operate as the personal-information provision apparatus 10, into a RAM (1002 or the like) and executing the computer program, and the storage apparatus (1004 or the like).

Further, the application unit 713 is realized by a CPU (1001 or the like) for reading a corresponding computer program, which is registered in the computer constituting the ASP server apparatus 71 by a provider who entrusts the operation of a service to the ASP foundation system 7, into a RAM (1002 or the like) and executing the computer program, a storage apparatus (1001 or the like) and a network interface (1005 or the like).

It is noted that, although two application units 713 (713A and 713B) are illustrated in FIG. 31 as an example, this does not limit the number of the application units provided in the ASP server apparatus 71 of the ASP foundation system 7 according to this embodiment.

The user management unit 711 stores preferences having been set by the user terminal 72. Further, the user management unit 711 provides the personal-information management unit 712 with a preference having been set by the user terminal 72. The personal-information management unit 712 stores personal information. The personal-information management unit 712 acquires a preference by requesting it to the user management unit 711, and provides personal information to the application unit 713 based on the acquired preference.

The application units 713A and 713B include service provision units 714A and 714B (hereinafter, collectively also referred to as a service provision unit 714) and personal-information transmission/reception units 715A and 715B (hereinafter, collectively also referred to as a personal-information transmission/reception unit 715), respectively. The service provision unit 714 provides the user terminal 72 with a service based on personal information.

The personal-information transmission/reception unit 715 configures an embodiment of the personal-information acquisition apparatus 20 and the personal-information provision apparatus 10 of the first embodiment described above. That is, the personal-information transmission/reception unit 715 includes the following units of the first embodiment: the personal-information request unit 201, the personal-information reception unit 202, the personal-information storage unit 101, the personal-information request reception unit 102, the preference request unit 103, the preference reception unit 104, the disclosure permission/non-permission determination unit 105 and the personal-information transmission unit 106.

The personal-information request unit 201 of the personal-information transmission/reception unit 715 requests a piece of personal information, which is needed for a service provision performed by the service provision unit 714, to the personal-information management unit 712 or the personal-information transmission/reception unit 715 of a different application unit 713, each of the personal-information management unit 712 and the personal-information transmission/reception unit 715 functioning as the personal-information provision apparatus 10. In this way, the personal-information request unit 201 of the personal-information transmission/reception unit 715 requests pieces of personal information to a respective plurality of personal-information provision apparatuses 10s in accordance with necessity.

The personal-information reception unit 202 of the personal-information transmission/reception unit 715 outputs acquired pieces of personal information to the service provision unit 714, and further, stores them into the personal-information storage unit 101. The personal-information request reception unit 102 of the personal-information transmission/reception unit 715 receives the personal information request message RM1 from the personal-information transmission/reception unit 715 of a different application unit 713. The preference request unit 103 of the personal-information transmission/reception unit 715 transmits the preference request message RM2 to the user management unit 711. Further, the preference reception unit 104 of the personal-information transmission/reception unit 715 acquires a preference from the user management unit 711.

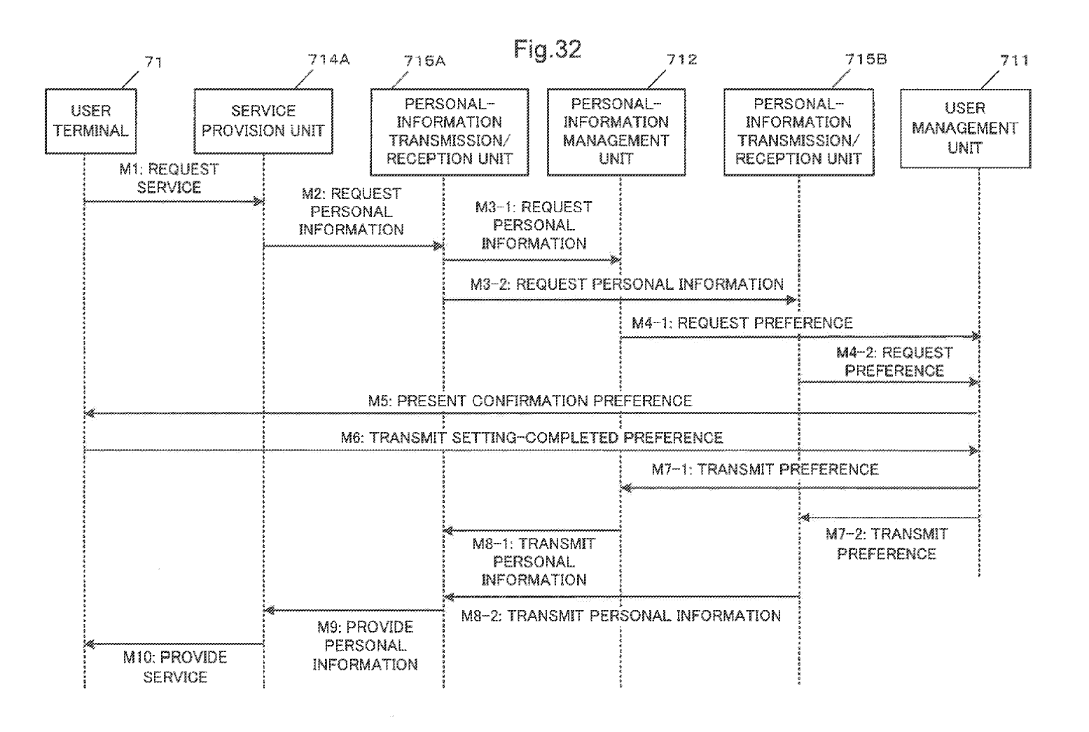

Operation of the ASP foundation system 7, which is configured in such a way as described above, will be described with reference to FIGS. 31 and 32.

First, the user terminal 72 requests a service provision to the service provision unit 714A of the application unit 713A (step M1). Next, since pieces of personal information are needed in the service provision, the service provision unit 714A requests the pieces of personal information to the personal-information transmission/reception unit 715A (step M2).

Next, the personal-information transmission/reception unit 715A requests the pieces of personal information to a respective plurality of apparatuses (steps M3-1 and M3-2). For example, the personal-information transmission/reception unit 715A transmits the personal information request messages RM1s to the personal-information transmission/reception unit 715B of the application unit 713B registered by a different provider, and the personal-information management unit 712 provided by the ASP foundation system 7, respectively.

Next, each of the personal-information transmission/reception unit 715B and the personal-information management unit 712 transmits the preference request message RM2 with respect to transmission and reception of the requested piece of personal information, to the user management unit 711 (steps M4-1 and M4-2).

Next, the user management unit 711 refers to past preferences stored in the preference storage unit 301, and thereby presents the confirmation preferences CPs to the user terminal 72 (step M5).

Next, the user management unit 711 acquires preferences having been set based on the confirmation preferences CPs, from the user terminal 72 (step M6).

Next, the user management unit 711 provides the acquired preferences to the personal-information transmission/reception unit 715B and the personal-information management unit 712, respectively (steps M7-1 and M7-2)

Next, each of the personal-information management unit 715B and the personal-information management unit 712 which have acquired the preferences, confirms the content of the preference, and provides the requested piece of personal information to the personal-information transmission/reception unit 715A (steps M8-1 and M8-2).

Next, the personal-information transmission/reception unit 715A, which has acquired the pieces of personal information, provides the pieces of personal information to the service provision unit 714A (step M9).

Next, the service provision unit 714A provides a service based on the acquired pieces of personal information to the user terminal 72 (step M10).

With the above processing, the ASP foundation system 7 terminates the operation.

In addition, in step M6, the user management unit 711 may acquire not only the contents of settings on preferences performed by the end user, but also the contents of settings performed by an administrator of the ASP foundation system 7 or the application unit 713. In the case where the content of settings on a preference performed by the administrator is acquired, the user management unit 711 may store a preference based on the acquired content of settings into the preference storage unit 301 as a preference which is applied when an individual preference by the user cannot be acquired.

Next, advantageous effects of the seventh embodiment according to the present invention will be described.

Even when the number of the application units possessing personal information has increased, the ASP foundation system 7 according to the seventh embodiment is able to reduce the burden of a user who sets preferences with respect to transmission and reception of the personal information. A reason of this is that the user management unit 711 acquires preferences with respect to disclosures of personal information from the personal-information management unit 712 and the individual application units (713A and 713B) to different application units, and the personal-information management unit 712 and the individual application units provide pieces of personal information to different application units based on the preferences having been acquired by the user management unit 711.

That is, since, in the ASP foundation system 7 according to the seventh embodiment, the user management unit 711 performs centralized management of preferences, even when the number of the application units which transmit and receive personal information has increased, a user does not need to set preferences with respect to personal information for each of the application units.

It is noted that, in the above-described individual embodiments according to the present invention, by storing each of the various pieces of processing including the preference request processing (FIG. 11, FIG. 16 and FIG. 19), the preference confirmation processing (FIG. 12 and FIG. 27), the personal information provision processing (FIG. 13) and the like, which have been described with reference to the individual flowcharts, into the nonvolatile storage medium (the storage device 1004 or the like) of the personal-information provision apparatus (10 or the like) or the preference management apparatus (30 or the like) in advance as a computer program, and reading the computer program into the CPU (1001 or the like) to execute it, the function of each of these pieces of processing can be realized. Further, in such a case, it is possible to understand that the present invention is also configured by codes representing the relevant computer programs, or storage media therefore.

Further, the individual embodiments described above can be carried out by being appropriately combined with one another.

Further, the present invention is not limited to the embodiments described above, and is able to be carried out in various forms.

In addition, part of or the whole of the embodiments described above is able to be also described just like following supplementary notes, but, is not limited to the following supplementary notes.

### (Supplementary Note 1)

A personal-information transmission/reception system including:

a personal-information acquisition apparatus;

a personal-information provision apparatus;

a preference management apparatus; and

a user terminal,

wherein the personal-information acquisition apparatus includes:
a personal-information request unit that transmits a personal information request message, which represents a request for personal information necessary for a service provision to the user terminal, to the personal-information provision apparatus, and
a personal-information reception unit that receives the personal information from the personal-information provision apparatus,

wherein the personal-information provision apparatus includes:
a personal-information storage unit that stores the personal information,
a personal-information request reception unit that receives the personal information request message from the personal-information acquisition apparatus,
a preference request unit that, in response to reception of the personal information request message, transmits a preference request message, which represents a request for a preference representing prescription with respect to a disclosure of the personal information, to the preference management apparatus,
a preference reception unit that receives the preference from the preference management apparatus,
a disclosure permission/non-permission determination unit that determines whether or not it is possible to disclose the personal information to the personal-information acquisition apparatus, based on the preference received by the preference reception unit, and
a personal-information transmission unit that, if it is determined by the disclosure permission/non-permission determination unit that it is possible to disclose the personal information, transmits the personal information to the personal-information acquisition apparatus,

wherein the preference management apparatus includes:
a preference storage unit that stores a preference which has been set in the past by the user terminal,
a preference request reception unit that receives the preference request message from the personal-information provision apparatus,
a confirmation preference generation unit that generates a confirmation preference which is to be presented to the user terminal based on the past preference stored in the preference storage unit as well as the preference request message,
a preference confirmation unit that presents the confirmation preference to the user terminal, and receives a preference, which is set based on the presented confirmation preference, form the user terminal, and
a preference transmission unit that transmits the preference received by the preference confirmation unit to the personal-information provision apparatus, and

wherein the user terminal includes:
a preference setting unit that sets a preference with respect to a disclosure of the personal information from the personal-information provision apparatus to the personal-information acquisition apparatus, based on the confirmation preference presented by the preference management apparatus, and transmits the preference having been set thereby to the preference management apparatus.

### (Supplementary Note 2)

The personal-information transmission/reception system according to supplementary note 1, wherein the confirmation preference generation unit of the preference management apparatus generates the confirmation preference based on a preference including the same information as at least part of information included in the preference request message among preferences stored in the preference storage unit.

### (Supplementary Note 3)

The personal-information transmission/reception system according to supplementary note 1 or supplementary note 2, wherein the preference management apparatus further includes:

a handling information storage unit that stores handling information with respect to handling of personal information in the personal-information provision apparatus and the personal-information acquisition apparatus, and

a confirmation preference estimation unit that generates the confirmation preference by extracting a similar preference with respect to a provision-source personal-information provision apparatus and a disclosure-destination personal-information acquisition apparatus which are similar to a provision-source personal-information provision apparatus and a disclosure-destination personal-information acquisition apparatus included in the preference request message, respectively, from among preferences stored in the preference storage unit, based on handling information which is related to individual apparatuses, and is stored in the handling information storage unit, and estimating the confirmation preference based on the extracted similar preference.

### (Supplementary Note 4)

The personal-information transmission/reception system according to supplementary note 3, wherein the confirmation preference estimation unit of the preference management apparatus classifies the personal-information provision apparatuses and the personal-information acquisition apparatuses based on the handling information storage unit, and extracts a preference, as the similar preference, which has been set in the past with respect to a disclosure of the personal information from a personal-information provision apparatus belonging to the same class as that of the provision-source personal-information provision apparatus included in the preference request message to a personal-information acquisition apparatus belonging to the same class as that of the disclosure-destination personal-information acquisition apparatus included in the preference request message.

### (Supplementary Note 5)

The personal-information transmission/reception system according to supplementary note 3 or supplementary note 4, wherein the confirmation preference estimation unit of the preference management apparatus calculates, based on preferences stored in the preference storage unit, evaluation values corresponding to kinds of personal information included in the individual preferences, as well as an evaluation value corresponding to a kind of personal information included in the preference request message, and thereby extracts a preference, as the similar preference, which is related to a disclosure of personal information of a kind corresponding to an evaluation value falling within a predetermined range determined from the evaluation value of the kind of the personal information included in the preference request message.

### (Supplementary Note 6)

The personal-information transmission/reception system according to any one of supplementary notes 1 to 5,

wherein the personal-information provision apparatus further includes:
a preference-management-apparatus information storage unit that stores information representing the preference management apparatus, and
a preference request destination determination unit that, in response to reception of the personal information request message, determines a preference management apparatus which becomes a request destination of a preference with respect to a disclosure of the personal information based on the preference-management-apparatus information storage unit, and

wherein the preference request unit transmits the preference request message to the preference management apparatus determined by the preference request destination determination unit.

### (Supplementary Note 7)

The personal-information transmission/reception system according to any one of supplementary notes 1 to 6,

wherein the personal-information provision apparatus further includes:
a preference storage unit that stores a preference acquired from the preference management apparatus, and
a preference acquisition unit that acquires a preference with respect to a disclosure of the personal information from the personal-information provision apparatus to the personal-information acquisition apparatus by retrieving the preference from the preference storage unit, and

wherein, in case that the preference with respect to a disclosure of the personal information from the personal-information provision apparatus to the personal-information acquisition apparatus is stored in the preference storage unit, the disclosure permission/non-permission determination unit determines whether or not it is possible to disclose the personal information to the personal-information acquisition apparatus, based on the preference acquired by the preference acquisition unit.

### (Supplementary Note 8)

The personal-information transmission/reception system according to any one of supplementary notes 1 to 7,

wherein the user terminal further includes:
a preference change content setting unit that transmits a change content of a preference, which has been set in the past with respect to a disclosure of the personal information, to the preference management apparatus, and

wherein the preference management apparatus further includes:
a change content acquisition unit that acquires the change content from the user terminal,
a preference updating unit that updates a preference, which is stored in the preference storage unit, based on the change content acquired by the change content acquisition unit,
a preference change notice generation unit that identifies a personal-information provision apparatus and a personal-information acquisition apparatus in relation to a preference which is updated by the preference updating unit, and generates a preference change notice to the identified personal-information provision apparatus and the personal-information acquisition apparatus, and
a preference change notice transmission unit that transmits the preference change notice to each of the personal-information provision apparatus and the personal-information acquisition apparatus identified by the preference change notice generation unit.

### (Supplementary Note 9)

A personal-information transmission/reception method for use in a personal-information acquisition apparatus, a personal-information provision apparatus, a preference management apparatus and a user terminal, the method including:

transmitting, by the personal-information acquisition apparatus, a personal information request message representing a request for personal information necessary for a service provision to the user terminal to the personal-information provision apparatus;

storing, by the personal-information provision apparatus, the personal information in advance;

receiving, by the personal-information provision apparatus, the personal information request message from the personal-information acquisition apparatus;

transmitting, by the personal-information provision apparatus, a preference request message, which represents a request for a preference representing prescription with respect to a disclosure of the personal information, to the preference management apparatus in response to reception of the personal information request message;

storing, by the preference management apparatus, a preference in advance, which has been set in the past by the user terminal, into a preference storage unit;

receiving, by the preference management apparatus, the preference request message from the personal-information provision apparatus;

generating, by the preference management apparatus, a confirmation preference which is to be presented to the user terminal based on the past preference stored in the preference storage unit as well as the preference request message;

presenting, by the preference management apparatus, the confirmation preference to the user terminal;

setting, by the user terminal, a preference with respect to a disclosure of the personal information from the personal-information provision apparatus to the personal-information acquisition apparatus, based on the confirmation preference presented by the preference management apparatus;

transmitting, by the user terminal, the preference having been set thereby to the preference management apparatus; receiving, by the preference management apparatus, the preference having been set thereby from the user terminal;

transmitting, by the preference management apparatus, the received preference to the personal-information provision apparatus; receiving, by the personal-information provision apparatus, the preference from the preference management apparatus;

determining, by the personal-information provision apparatus, whether or not it is possible to disclose the personal information to the personal-information acquisition apparatus; transmitting, by the personal-information provision apparatus, the personal information to the personal-information acquisition apparatus if it is determined that it is possible to disclose the personal information; and

receiving, by the personal-information acquisition apparatus, the personal information from the personal-information provision apparatus.

### (Supplementary Note 10)

The personal-information transmission/reception method according to supplementary note 9, wherein, when generating a confirmation preference which is to be presented to the user terminal, the confirmation preference generation unit generates the confirmation preference based on a preference including the same information as at least part of information included in the preference request message among preferences stored in the preference storage unit.

### (Supplementary Note 11)

A personal-information provision apparatus including:

a personal-information storage unit that stores the personal information;

a personal-information request reception unit that receives a personal information request message, which represents a request for the personal information, from the personal-information acquisition apparatus;

a preference request unit that transmits a preference request message, which represents a request for a preference representing prescription with respect to a disclosure of the personal information, to the preference management apparatus in response to reception of the personal information request message;

a preference reception unit that receives the preference from the preference management apparatus;

a disclosure permission/non-permission determination unit that determines whether or not it is possible to disclose the personal information to the personal-information acquisition apparatus, based on the preference received by the preference reception unit; and

a personal-information transmission unit that, if it is determined by the disclosure permission/non-permission determination unit that it is possible to disclose the personal information, transmits the personal information to the personal-information acquisition apparatus.

### (Supplementary Note 12)

The personal-information provision apparatus according to supplementary note 11, further including:

a preference storage unit that stores a preference acquired from the preference management apparatus, and

a preference acquisition unit that acquires a preference with respect to a disclosure of the personal information to the personal-information acquisition apparatus by retrieving the preference from the storage unit,

wherein, in case that the preference with respect to a disclosure of the personal information from the personal-information provision apparatus to the personal-information acquisition apparatus is stored in the preference storage unit, the disclosure permission/non-permission determination unit determines whether or not it is possible to disclose the personal information to the personal-information acquisition apparatus, based on the preference acquired by the preference acquisition unit.

### (Supplementary Note 13)

A preference management apparatus including:

a preference storage unit that stores a preference which has been set in the past by the user terminal, and which represents prescription with respect to a disclosure from a personal-information provision apparatus to a personal-information acquisition apparatus;

a preference request reception unit that receives the preference request message from the personal-information provision apparatus;

a confirmation preference generation unit that generates a confirmation preference which is to be presented to the user terminal based on the past preference stored in the preference storage unit as well as the preference request message;

a preference confirmation unit that presents the confirmation preference to the user terminal, and receives a preference, which is set based on the presented confirmation preference, form the user terminal; and

a preference transmission unit that transmits the preference received by the preference confirmation unit to the personal-information provision apparatus.

### (Supplementary Note 14)

The preference management apparatus according to supplementary Note 13, wherein the confirmation preference generation unit generates the confirmation preference based on a preference including the same information as at least part of information included in the preference request message among preferences stored in the preference storage unit.

### (Supplementary Note 15)

A computer program causing a computer to execute:

a personal information storing step of storing personal information;

a personal information request receiving step of receiving a personal information request message representing a request for the personal information from a personal-information acquisition apparatus;

a preference requesting step of transmitting a preference request message representing a request for a preference representing prescription with respect to a disclosure of the personal information in response to reception of the personal information request message;

a preference receiving step of receiving the preference from the preference management apparatus;

a disclosure permission/non-permission determining step of determining whether or not it is possible to disclose the personal information to the personal-information acquisition apparatus; and

a personal information transmitting step of transmitting the personal information to the personal-information acquisition apparatus if it is determined that it is possible to disclose the personal information.

### (Supplementary Note 16)

The computer program according to supplementary note 15, causing the computer to execute:

a preference storing step of storing a preference acquired from the preference management apparatus in advance; and

a preference acquiring step of acquiring a preference with respect to a disclosure of the personal information to the personal-information acquisition apparatus by retrieving the preference from the preference storage unit,

wherein, in the disclosure permission/non-permission determining step, if the preference with respect to a disclosure of the personal information from the personal-information provision apparatus to the personal-information acquisition apparatus is stored in the preference storage unit, it is determined whether or not it is possible to disclose the personal information to the personal-information acquisition apparatus, based on the preference acquired in the preference acquiring step.

### (Supplementary Note 17)

A computer program causing a computer to execute:

a preference storing step of storing a preference, which has been set in the past by a user terminal, and which represents prescription with respect to a disclosure of personal information from a personal-information provision apparatus to a personal-information acquisition apparatus, into a preference storage unit;

a preference request receiving step of receiving the preference request message from the personal-information provision apparatus;

a confirmation preference generating step of generating a confirmation preference which is to be presented to the user terminal based on the past preference stored in the preference storage unit as well as the preference request message;

a preference confirming step of presenting the confirmation preference to the user terminal, and receiving a preference, which is set based on the presented confirmation preference, from the user terminal; and

a preference transmitting step of transmitting the preference received in the preference confirming step to the personal-information provision apparatus.

### (Supplementary Note 18)

The computer program according to supplementary note 17, wherein, in the confirmation preference generating step, the confirmation preference is generated based on a preference including the same information as at least part of information included in the preference request message among preferences stored in the preference storage unit.

Hereinbefore, the present invention has been described by taking the aforementioned exemplary embodiments as exemplary examples. However, the present invention is not limited to the aforementioned exemplary embodiments. That is, various forms which can be understood by those skilled in the art can be applied to the present invention within the scope of the present invention.

This application is based upon and claims the benefit of priority from Japanese Patent Application No. 2010-225741 filed on Oct. 5, 2010, the disclosure of which is incorporated herein in its entirety by reference.

### REFERENCE OF SIGN LIST

1 2, 3, 4 and 5: Personal-information transmission/reception system
6: Mobile-telephone-terminal shopping portal system
7: ASP foundation system
9: Network
10, 50 and 60: Personal-information provision apparatus
20: Personal-information acquisition apparatus
30, 70 and 90: Preference management apparatus
40 and 80: User terminal
61: Shopping portal
62: Content provider
63: Mobile carrier
64: Mobile telephone terminal
71: ASP server apparatus
72: User terminal,
101: Personal-information storage unit,
102: Personal-information request reception unit,
103 and 603: Preference request unit,
104: Preference reception unit,
105 and 605: Disclosure permission/non-permission determination unit,
106: Personal-information transmission unit,
201: Personal-information request unit,
202: Personal-information reception unit,
301: Preference storage unit,
302: Preference request reception unit,
303: Confirmation preference generation unit,
304: Preference confirmation unit,
305: Preference transmission unit,
401: Preference setting unit,
507: Preference-management-apparatus information storage unit,
508: Preference request destination determination unit,
609: Preference storage unit,
610: Preference acquisition unit,
706: Content-change acquisition unit,
707: Preference updating unit,
708: Change notice generation unit,
709: Change notice transmission unit,
711: User management unit,
712: Personal-information management unit,
713: Application unit,
714: Service provision unit,
715: Personal-information transmission/reception unit,
802: Preference change content setting unit,
910: Cooperation-apparatus-information storage unit,
911: Handling information storage unit,
912: Handling information acquisition unit,
913: Confirmation preference estimation unit

1. A personal-information transmission/reception system comprising:
a personal-information acquisition apparatus;
a personal-information provision apparatus;
a preference management apparatus; and
a user terminal,
wherein the personal-information acquisition apparatus includes:
a personal-information request unit to transmit a personal information request message, which represents a request for personal information necessary for a service provision to the user terminal, to the personal-information provision apparatus, and
a personal-information reception unit to receive the personal information from the personal-information provision apparatus,
wherein the personal-information provision apparatus includes:
a personal-information storage unit to store the personal information,
a personal-information request reception unit to receive the personal information request message from the personal-information acquisition apparatus,
a preference request unit to, in response to reception of the personal information request message, transmit a preference request message, which represents a request for a preference representing prescription with respect to a disclosure of the personal information, to the preference management apparatus,
a preference reception unit to receive the preference from the preference management apparatus,
a disclosure permission/non-permission determination unit to determine whether or not it is possible to disclose the personal information to the personal-information acquisition apparatus, based on the preference received by the preference reception unit, and
a personal-information transmission unit to, if it is determined by the disclosure permission/non-permission determination unit that it is possible to disclose the personal information, read out the personal information from the personal information storage unit, and transmit the read-out personal information to the personal-information acquisition apparatus,
wherein the preference management apparatus includes:
a preference storage unit to store a preference which has been set in the past by the user terminal,
a preference request reception unit to receive the preference request message from the personal-information provision apparatus,
a confirmation preference generation unit to generate a confirmation preference which is to be presented to the user terminal based on the past preference stored in the preference storage unit as well as the preference request message,
a preference confirmation unit to present the confirmation preference to the user terminal, and receive a preference, which is set based on the presented confirmation preference, form the user terminal, and
a preference transmission unit to transmit the preference received by the preference confirmation unit to the personal-information provision apparatus, and
wherein the user terminal includes:
a preference setting unit to set a preference with respect to a disclosure of the personal information from the personal-information provision apparatus to the personal-information acquisition apparatus, based on the confirmation preference presented by the preference management apparatus, and transmit the preference having been set thereby to the preference management apparatus.

2. The personal-information transmission/reception system according to claim 1, wherein the confirmation preference generation unit of the preference management apparatus generates the confirmation preference based on a preference including the same information as at least part of information included in the preference request message among preferences stored in the preference storage unit.

3. The personal-information transmission/reception system according to claim 1, wherein the preference management apparatus further includes:
a handling information storage unit to store handling information with respect to handling of personal information in the personal-information provision apparatus and the personal-information acquisition apparatus, and
a confirmation preference estimation unit to generate the confirmation preference by extracting a similar preference with respect to a provision-source personal-information provision apparatus and a disclosure-destination personal-information acquisition apparatus which are similar to a provision-source personal-information provision apparatus and a disclosure-destination personal-information acquisition apparatus included in the preference request message, respectively, from among preferences stored in the preference storage unit, based on handling information which is related to individual apparatuses, and is stored in the handling information storage unit, and estimate the confirmation preference based on the extracted similar preference.

4. The personal-information transmission/reception system according to claim 3, wherein the confirmation preference estimation unit of the preference management apparatus classifies the personal-information provision apparatuses and the personal-information acquisition apparatuses based on the handling information storage unit, and extracts a preference, as the similar preference, which has been set in the past with respect to a disclosure of the personal information from a personal-information provision apparatus belonging to the same class as that of the provision-source personal-information provision apparatus included in the preference request message to a personal-information acquisition apparatus belonging to the same class as that of the disclosure-destination personal-information acquisition apparatus included in the preference request message.

5. The personal-information transmission/reception system according to claim 3, wherein the confirmation preference estimation unit of the preference management apparatus calculates, based on preferences stored in the preference storage unit, evaluation values corresponding to kinds of personal information included in the individual preferences, as well as an evaluation value corresponding to a kind of personal information included in the preference request message, and thereby extracts a preference, as the similar preference, which is related to a disclosure of personal information of a kind corresponding to an evaluation value falling within a predetermined range determined from the evaluation value of the kind of the personal information included in the preference request message.

6. The personal-information transmission/reception system according to claim 1, wherein
the personal-information provision apparatus further includes:
a preference-management-apparatus information storage unit to storage information representing the preference management apparatus, and
a preference request destination determination unit to, in response to reception of the personal information request message, determine a preference management apparatus which becomes a request destination of a preference with respect to a disclosure of the personal information based on the preference-management-apparatus information storage unit, and
wherein the preference request unit transmits the preference request message to the preference management apparatus determined by the preference request destination determination unit.

7. The personal-information transmission/reception system according to claim 1, wherein
the personal-information provision apparatus further includes:
a preference storage unit to store a preference acquired from the preference management apparatus, and
a preference acquisition unit to acquire a preference with respect to a disclosure of the personal information from the personal-information provision apparatus to the personal-information acquisition apparatus by retrieving the preference from the preference storage unit, and
wherein, in the case where the preference with respect to a disclosure of the personal information from the personal-information provision apparatus to the personal-information acquisition apparatus is stored in the preference storage unit, the disclosure permission/non-permission determination unit determines whether or not it is possible to disclose the personal information to the personal-information acquisition apparatus, based on the preference acquired by the preference acquisition unit.

8. The personal-information transmission/reception system according to claim 1, wherein
the user terminal further includes:
a preference change content setting unit to transmit a change content of a preference, which has been set in the past with respect to a disclosure of the personal information, to the preference management apparatus, and
the preference management apparatus further includes:
a change content acquisition unit to acquire the change content from the user terminal,
a preference updating unit to update a preference, which is stored in the preference storage unit, based on the change content acquired by the change content acquisition unit,
a preference change notice generation unit to identify a personal-information provision apparatus and a personal-information acquisition apparatus in relation to a preference which is updated by the preference updating unit, and generate a preference change notice to the identified personal-information provision apparatus and personal-information acquisition apparatus, and
a preference change notice transmission unit to transmit the preference change notice to each of the personal-information provision apparatus and the personal-information acquisition apparatus identified by the preference change notice generation unit.

9. A personal-information transmission/reception method for use in a personal-information acquisition apparatus, a personal-information provision apparatus, a preference management apparatus and a user terminal, the personal-information transmission/reception method comprising:
transmitting, by the personal-information acquisition apparatus, a personal information request message representing a request for personal information necessary for a service provision to the user terminal to the personal-information provision apparatus;
storing, by the personal-information provision apparatus, the personal information in advance;
receiving, by the personal-information provision apparatus, the personal information request message from the personal-information acquisition apparatus;
transmitting, by the personal-information provision apparatus, a preference request message, which represents a request for a preference representing prescription with respect to a disclosure of the personal information, to the preference management apparatus in response to reception of the personal information request message; storing, by the preference management apparatus, a preference in advance, which has been set in the past by the user terminal, into a preference storage unit;
receiving, by the preference management apparatus, the preference request message from the personal-information provision apparatus;
generating, by the preference management apparatus, a confirmation preference which is to be presented to the user terminal based on the past preference stored in the preference storage unit as well as the preference request message;
presenting, by the preference management apparatus, the confirmation preference to the user terminal;
setting, by the user terminal, a preference with respect to a disclosure of the personal information from the personal-information provision apparatus to the personal-information acquisition apparatus, based on the confirmation preference presented by the preference management apparatus;
transmitting, by the user terminal, the preference having been set thereby to the preference management apparatus;
receiving, by the preference management apparatus, the preference having been set thereby from the user terminal;
transmitting, by the preference management apparatus, the received preference to the personal-information provision apparatus;
receiving, by the personal-information provision apparatus, the preference from the preference management apparatus;
determining, by the personal-information provision apparatus, whether or not it is possible to disclose the personal information to the personal-information acquisition apparatus;
reading out, by the personal-information provision apparatus, the personal information from the personal-information storage unit to transmit the read-out personal information to the personal-information acquisition apparatus if it is determined that it is possible to disclose the personal information; and
receiving, by the personal-information acquisition apparatus, the personal information from the personal-information provision apparatus.

10. The personal-information transmission/reception method according to claim 9, wherein, when generating a confirmation preference which is to be presented to the user terminal, the confirmation preference generation unit generates the confirmation preference based on a preference including the same information as at least part of information included in the preference request message among preferences stored in the preference storage unit.

11. A personal-information provision apparatus comprising:
a personal-information storage unit to storage the personal information;
a personal-information request reception unit to receive a personal information request message, which represents a request for the personal information, from the personal-information acquisition apparatus;
a preference request unit to transmit a preference request message, which represents a request for a preference representing prescription with respect to a disclosure of the personal information, to the preference management apparatus in response to reception of the personal information request message;
a preference reception unit to receive the preference from the preference management apparatus;
a disclosure permission/non-permission determination means that determines unit to determine whether or not it is possible to disclose the personal information to the personal-information acquisition apparatus, based on the preference received by the preference reception unit, and
a personal-information transmission unit to, if it is determined by the disclosure permission/non-permission determination unit that it is possible to disclose the personal information, read out the personal information from the personal-information storage unit, and transmit the read-out personal information to the personal-information acquisition apparatus.

12. The personal-information provision apparatus according to claim 11, further comprising:
a preference storage unit to store a preference acquired from the preference management apparatus, and
a preference acquisition unit to acquire a preference with respect to a disclosure of the personal information to the personal-information acquisition apparatus by retrieving the preference from the storage unit,
wherein, in the case where the preference with respect to a disclosure of the personal information from the personal-information provision apparatus to the personal-information acquisition apparatus is stored in the preference storage unit, the disclosure permission/non-permission determination unit determines whether or not it is possible to disclose the personal information to the personal-information acquisition apparatus, based on the preference acquired by the preference acquisition unit.

13. A preference management apparatus comprising:
a preference storage unit to store a preference which has been set in the past by the user terminal, and which represents prescription with respect to a disclosure from a personal-information provision apparatus to a personal-information acquisition apparatus;
a preference request reception unit to receive the preference request message from the personal-information provision apparatus;
a confirmation preference generation unit to generate a confirmation preference which is to be presented to the user terminal based on the past preference stored in the preference storage unit as well as the preference request message;
a preference confirmation unit to present the confirmation preference to the user terminal, and receive a preference, which is set based on the presented confirmation preference, form the user terminal; and
a preference transmission unit to transmit the preference received by the preference confirmation unit to the personal-information provision apparatus.

14. The preference management apparatus according to claim 13, the confirmation preference generation unit generates the confirmation preference based on a preference including the same information as at least part of information included in the preference request message among preferences stored in the preference storage unit.

15. A non-transitory storage media storing a computer program causing a computer to execute:
a personal information storing function to store personal information in a personal-information storage apparatus;
a personal information request function to receive a personal information request message representing a request for the personal information from a personal-information acquisition apparatus;
a preference requesting function to transmit a preference request message, to a preference management apparatus, representing a request for a preference representing prescription with respect to a disclosure of the personal information in response to reception of the personal information request message;
a preference receiving function to receive the preference from the preference management apparatus;
a disclosure permission/non-permission determining function to determine whether or not it is possible to disclose the personal information to the personal-information acquisition apparatus; and
a personal information transmitting function to read out the personal information from a personal-information storage unit, and transmit the read-out personal information to the personal-information acquisition apparatus if it is determined that it is possible to disclose the personal information.

16. The non-transitory storage media according to claim 15, causing the computer to execute:
a preference storing function to store a preference, in a preference storage apparatus, acquired from the preference management apparatus; and
a preference acquiring function to acquire a preference with respect to a disclosure of the personal information to the personal-information acquisition apparatus by retrieving the preference from the preference storage apparatus,
wherein, by the disclosure permission/non-permission determining function, if the preference with respect to a disclosure of the personal information from the personal-information provision apparatus to the personal-information acquisition apparatus is stored in the preference storage unit, it is determined whether or not it is possible to disclose the personal information to the personal-information acquisition apparatus, based on the preference acquired by the preference acquiring function.

17. A non-transitory storage media storing a computer program causing a computer to execute:
a preference storing function to store a preference, which has been set in the past by a user terminal, and which represents prescription with respect to a disclosure of personal information from a personal-information provision apparatus to a personal-information acquisition apparatus, into a preference storage apparatus;
a preference request receiving function to receive the preference request message from the personal-information provision apparatus;
a confirmation preference generating function to generate a confirmation preference which is to be presented to the user terminal based on the past preference stored in the preference storage apparatus as well as the preference request message;
a preference confirming function to present the confirmation preference to the user terminal, and receive a preference which is set based on the presented confirmation preference from the user terminal; and
a preference transmitting function to transmit the preference received by the preference confirming function to the personal-information provision apparatus.

18. The non-transitory storage media according to claim 17, characterized in that, by the confirmation preference generating function, the confirmation preference is generated based on a preference including the same information as at least part of information included in the preference request message among preferences stored in the preference storage apparatus.
